(19) United States
(12) Patent Application Publication
(10) Pub. No.: US 2019/0251146 A1
(43) Pub. Date: Aug. 15, 2019

(54) DEVICE FOR RENDERING MARKUP LANGUAGE WITH STRUCTURED DATA

(71) Applicant: Pearson Education, Inc., New York, NY (US)

(72) Inventors: Adam Finn, Brooklyn, NY (US); Hari Gangadharan, Dublin, CA (US); Michael Pace, Highlands Ranch, CO (US); Ted Leonard, Castle Rock, CO (US)

(21) Appl. No.: 15/897,128

(22) Filed: Feb. 14, 2018

(51) Int. Cl. G06F 17/22; G06F 17/27; G06F 17/30

(52) U.S. Cl. CPC G06F 17/2247; G06F 17/30327; G06F 17/272; G06F 17/2264

(57) ABSTRACT

A destination user device is configured to read and render a custom tag and markup language for presentation at the user device. The configuration at the user device may access resource identification locations (e.g., uniform resource identifiers, uniform resource locations, etc.) to extract content from a database and provide for display at the user device, authenticate credentials, format the data for a standardized look and feel, and other features to improve electronic transmissions between these improved systems.

### CROSS-REFERENCES TO RELATED APPLICATIONS

The present application is related to U.S. Non-Provisional patent application Ser. No. 15/897,071 [Attorney Docket No. 056838-0404.00.0.US-1063699], entitled “Content Management Infrastructure for Conversion of Structured Data”; U.S. Non-Provisional patent application Ser. No. 15/897,112 [Attorney Docket No. 056838-0404.01.0.US-1071291], entitled “System for Markup Language Conversion”; each of which is assigned to the same assignee and incorporated herein by reference in its entirety for all purposes.

### BACKGROUND

A computer network or data network is a telecommunications network which allows computers to exchange data. In computer networks, networked computing devices exchange data with each other along network links (data connections). The connections between nodes are established using either cable media or wireless media. The best-known computer network is the Internet.

Network computer devices that originate, route, and terminate the data are called network nodes. Nodes can include hosts such as personal computers, phones, servers, as well as networking hardware. Two such devices can be said to be networked together when one device is able to exchange information with the other device, whether or not they have a direct connection to each other.

Computer networks differ in the transmission media used to carry their signals, the communications protocols to organize network traffic, the network's size, topology and organizational intent. In most cases, communications protocols are layered on (i.e. work using) other more specific or more general communications protocols, except for the physical layer that directly deals with the transmission media.

Some communication protocols are not enabled to render formatting of data for particular nodes that transmit electronic indications through a common communication network. Improvements are needed to the computer network and nodes of the network in order to enable the formatting of data to be generated, rendered, transmitted, and presented at the destination node.

### BRIEF SUMMARY

One aspect of the present disclosure relates to systems and methods for rendering a markup language document, the method comprising: receiving, by a structured content application provided by a processor, a markup document, wherein the markup document comprises a standard markup tag and a structured content markup tag; parsing the markup document to generate a document object management tree that comprises entries for the standard markup tag, the structured content markup tag, and a structured data in the document object management tree; rendering the document object management tree based at least on the parsing; accessing a resource identification location associated with the structured data, wherein: the resource identification location corresponds with a structured data object to display with an object layout, and the structured data object is populated with at least a portion of the structured data from the markup document; recursively generating the object layout that represents the rendered document object management tree, the object layout comprising at least the structured data object and a standard data object corresponding with the standard markup tag from the markup document; and providing the object layout via the structured content application.

### BRIEF DESCRIPTION OF THE DRAWINGS

FIG. 1 is a block diagram illustrating an example of a content distribution network.

FIG. 2 is a block diagram illustrating a computer server and computing environment within a content distribution network.

FIG. 3 is a block diagram illustrating an embodiment of one or more data store servers within a content distribution network.

FIG. 4 is a block diagram illustrating an embodiment of one or more content management servers within a content distribution network.

FIG. 5 is a block diagram illustrating the physical and logical components of a special-purpose computer device within a content distribution network.

FIG. 6 is a block diagram illustrating one embodiment of the communication network.

FIG. 7 is a block diagram illustrating one embodiment of user device and supervisor device communication.

FIG. 8 is a schematic illustration of one embodiment of a computing stack.

FIG. 9 is an illustrative flowchart of improved systems and methods that provide distribution and conversion of structured data according to an embodiment of the disclosure.

FIG. 10 is an illustrative flowchart of improved systems and methods that provide distribution and conversion of structured data according to an embodiment of the disclosure.

FIG. 11 is a block diagram illustrating an embodiment of one or more content management servers within a content distribution network according to an embodiment of the disclosure.

FIG. 12 is an illustrative flowchart related to the conversion of content to structured data according to an embodiment of the disclosure.

FIGS. 13-18 are illustrative user interfaces for determining structured data according to an embodiment of the disclosure.

FIG. 19 is an illustrative flowchart related to the conversion of content to structured data according to an embodiment of the disclosure.

FIG. 20 is an illustrative markup document according to an embodiment of the disclosure.

FIG. 21 is an illustrative markup document with a corresponding template according to an embodiment of the disclosure.

FIG. 22 is an illustrative markup document according to an embodiment of the disclosure.

FIG. 23 is a block diagram illustrating an embodiment of one or more user devices within a content distribution network according to an embodiment of the disclosure.

FIG. 24 is an illustrative flowchart related to the conversion structured data to an object layout according to an embodiment of the disclosure.

FIG. 25 is an illustrative parsing tree related to the conversion structured data to an object layout according to an embodiment of the disclosure.

FIG. 26 is an illustrative user interface infrastructure component according to an embodiment of the disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides illustrative embodiment(s) only and is not intended to limit the scope, applicability, or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

Embodiments of the application describe various improvements to systems, methods, and devices throughout the communication network described herein. For example, a user interface (UI) at a content management system may accept data to render and provide to other devices on the network using standard markup tags and structured content markup tags that may be unique to the content management system and the destination device. In another example, embodiments of the application may describe a novel tag generation process for a computing markup language. The UI at the content management system may create the structured content markup tags with a markup language document that may be configured to generate a custom document at a destination user device that may not rely on code-based instructions, like JavaScript. Instead, some embodiments of the application may be markup language based so that the instructions are portable across platforms and communication protocols. In another example, the destination user device may be configured to read and render the custom tag and markup language for presentation at the user device. The configuration at the user device may access to resource identification location (e.g., uniform resource identifiers, uniform resource location, etc.), extract content from a database and provide for display at the user device, authenticate credentials, format the data for a standardized look and feel, and other features to improve electronic transmissions between these improved systems.

Technical improvements are realized throughout the application with respect to conventional systems. For example, embodiments of the application improve the transmission of electronic communications between the content management system and one or more user devices that implement different communication protocols. Electronic communications that would be delayed between the standard systems and user devices are expedited and efficiently transmitted between the improved content management system and the various destination devices running on different protocols and platforms.

The structured content markup tags in communication with the rendering application at the user device may also provide several technical improvements. For example, conventional systems may receive data for presentation at the user devices that do not have a standardized look and feel across different platforms. The user device, in turn, may be limited to receiving data that can be unreadable or presented in frames that are too small for some easy devices to accurately display. The rendering application may be tailored for the particular protocol or platform implemented by the user device to accurately provide the data that is received from the improved content management system.

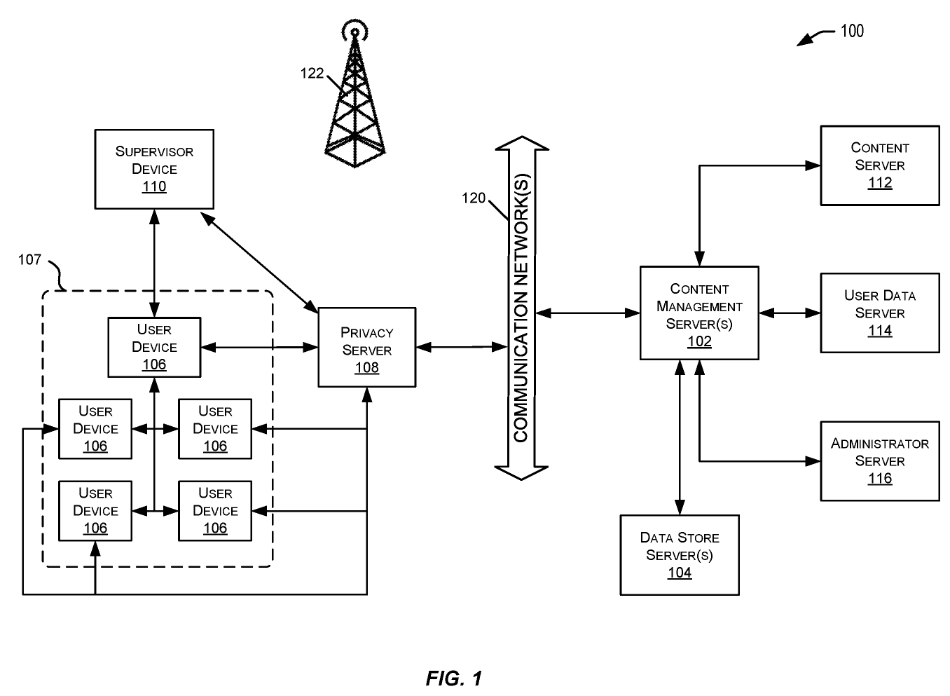

With reference now to FIG. 1, a block diagram is shown illustrating various components of a content distribution network (CDN) 100 which implements and supports certain embodiments and features described herein. In some embodiments, the content distribution network 100 can comprise one or several physical components and/or one or several virtual components such as, for example, one or several cloud computing components. In some embodiments, the content distribution network 100 can comprise a mixture of physical and cloud computing components.

Content distribution network 100 may include one or more content management servers 102. As discussed below in more detail, content management servers 102 may be any desired type of server including, for example, a rack server, a tower server, a miniature server, a blade server, a mini rack server, a mobile server, an ultra-dense server, a super server, or the like, and may include various hardware components, for example, a motherboard, a processing unit, memory systems, hard drives, network interfaces, power supplies, etc. Content management server 102 may include one or more server farms, clusters, or any other appropriate arrangement and/or combination or computer servers. Content management server 102 may act according to stored instructions located in a memory subsystem of the server 102, and may run an operating system, including any commercially available server operating system and/or any other operating systems discussed herein.

The content distribution network 100 may include one or more data store servers 104, such as database servers and file-based storage systems. The database servers 104 can access data that can be stored on a variety of hardware components. These hardware components can include, for example, components forming tier 0 storage, components forming tier 1 storage, components forming tier 2 storage, and/or any other tier of storage. In some embodiments, tier 0 storage refers to storage that is the fastest tier of storage in the database server 104, and particularly, the tier 0 storage is the fastest storage that is not RAM or cache memory. In some embodiments, the tier 0 memory can be embodied in solid state memory such as, for example, a solid-state drive (SSD) and/or flash memory.

In some embodiments, the tier 1 storage refers to storage that is one or several higher performing systems in the memory management system, and that is relatively slower than tier 0 memory, and relatively faster than other tiers of memory. The tier 1 memory can be one or several hard disks that can be, for example, high-performance hard disks. These hard disks can be one or both of physically or communicatively connected such as, for example, by one or several fiber channels. In some embodiments, the one or several disks can be arranged into a disk storage system, and specifically can be arranged into an enterprise class disk storage system. The disk storage system can include any desired level of redundancy to protect data stored therein, and in one embodiment, the disk storage system can be made with grid architecture that creates parallelism for uniform allocation of system resources and balanced data distribution.

In some embodiments, the tier 2 storage refers to storage that includes one or several relatively lower performing systems in the memory management system, as compared to the tier 1 and tier 2 storages. Thus, tier 2 memory is relatively slower than tier 1 and tier 0 memories. Tier 2 memory can include one or several SATA-drives (e.g., Serial AT Attachment drives) or one or several NL-SATA drives (e.g., Near Line Serial AT Attachment drives).

In some embodiments, the one or several hardware and/or software components of the database server 104 can be arranged into one or several storage area networks (SAN), which one or several storage area networks can be one or several dedicated networks that provide access to data storage, and particularly that provides access to consolidated, block level data storage. A SAN typically has its own network of storage devices that are generally not accessible through the local area network (LAN) by other devices. The SAN allows access to these devices in a manner such that these devices appear to be locally attached to the user device.

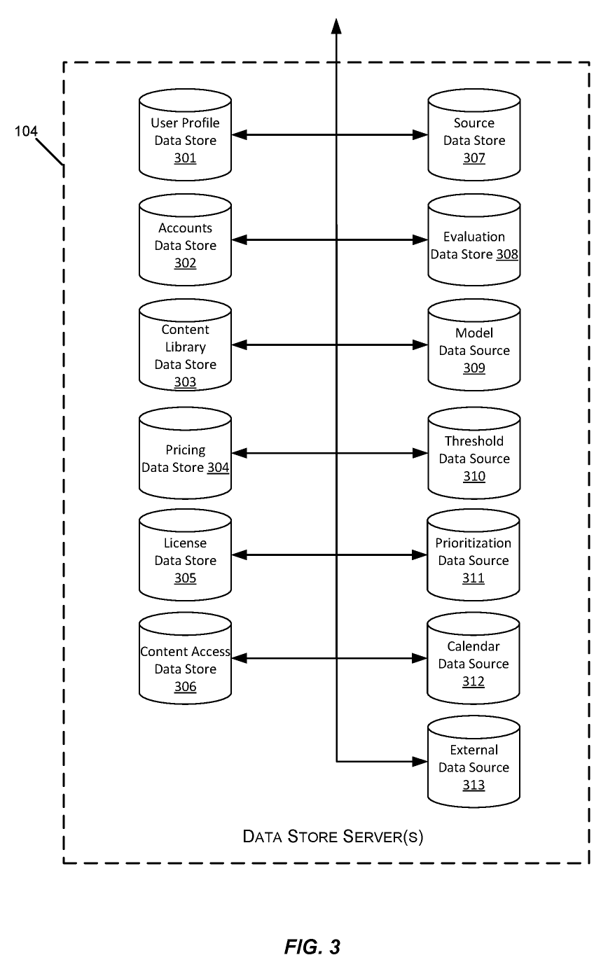

Data stores 104 may comprise stored data relevant to the functions of the content distribution network 100. Illustrative examples of data stores 104 that may be maintained in certain embodiments of the content distribution network 100 are described below in reference to FIG. 3. In some embodiments, multiple data stores may reside on a single server 104, either using the same storage components of server 104 or using different physical storage components to assure data security and integrity between data stores. In other embodiments, each data store may have a separate dedicated data store server 104.

Content distribution network 100 also may include one or more user devices 106 and/or supervisor devices 110. User devices 106 and supervisor devices 110 may display content received via the content distribution network 100, and may support various types of user interactions with the content. User devices 106 and supervisor devices 110 may include mobile devices such as smartphones, tablet computers, personal digital assistants, and wearable computing devices. Such mobile devices may run a variety of mobile operating systems and may be enabled for Internet, e-mail, short message service (SMS), Bluetooth®, mobile radio-frequency identification (M-RFID), and/or other communication protocols. Other user devices 106 and supervisor devices 110 may be general purpose personal computers or special-purpose computing devices including, by way of example, personal computers, laptop computers, workstation computers, projection devices, and interactive room display systems. Additionally, user devices 106 and supervisor devices 110 may be any other electronic devices, such as a thin-client computers, an Internet-enabled gaming systems, business or home appliances, and/or a personal messaging devices, capable of communicating over network(s) 120.

In different contexts of content distribution networks 100, user devices 106 and supervisor devices 110 may correspond to different types of specialized devices, for example, student devices and teacher devices in an educational network, employee devices and presentation devices in a company network, different gaming devices in a gaming network, etc. In some embodiments, user devices 106 and supervisor devices 110 may operate in the same physical location 107, such as a classroom or conference room. In such cases, the devices may contain components that support direct communications with other nearby devices, such as wireless transceivers and wireless communications interfaces, Ethernet sockets or other Local Area Network (LAN) interfaces, etc. In other implementations, the user devices 106 and supervisor devices 110 need not be used at the same location 107, but may be used in remote geographic locations in which each user device 106 and supervisor device 110 may use security features and/or specialized hardware (e.g., hardware-accelerated SSL and HTTPS, WS-Security, firewalls, etc.) to communicate with the content management server 102 and/or other remotely located user devices 106. Additionally, different user devices 106 and supervisor devices 110 may be assigned different designated roles, such as presenter devices, teacher devices, administrator devices, or the like, and in such cases the different devices may be provided with additional hardware and/or software components to provide content and support user capabilities not available to the other devices.

The content distribution network 100 also may include a privacy server 108 that maintains private user information at the privacy server 108 while using applications or services hosted on other servers. For example, the privacy server 108 may be used to maintain private data of a user within one jurisdiction even though the user is accessing an application hosted on a server (e.g., the content management server 102) located outside the jurisdiction. In such cases, the privacy server 108 may intercept communications between a user device 106 or supervisor device 110 and other devices that include private user information. The privacy server 108 may create a token or identifier that does not disclose the private information and may use the token or identifier when communicating with the other servers and systems, instead of using the user's private information.

As illustrated in FIG. 1, the content management server 102 may be in communication with one or more additional servers, such as a content server 112, a user data server 114, and/or an administrator server 116. Each of these servers may include some or all of the same physical and logical components as the content management server(s) 102, and in some cases, the hardware and software components of these servers 112-116 may be incorporated into the content management server(s) 102, rather than being implemented as separate computer servers.

Content server 112 may include hardware and software components to generate, store, and maintain the content resources for distribution to user devices 106 and other devices in the network 100. For example, in content distribution networks 100 used for professional training and educational purposes, content server 112 may include data stores of training materials, presentations, plans, syllabi, reviews, evaluations, interactive programs and simulations, course models, course outlines, and various training interfaces that correspond to different materials and/or different types of user devices 106. In content distribution networks 100 used for media distribution, interactive gaming, and the like, a content server 112 may include media content files such as music, movies, television programming, games, and advertisements.

User data server 114 may include hardware and software components that store and process data for multiple users relating to each user's activities and usage of the content distribution network 100. For example, the content management server 102 may record and track each user's system usage, including their user device 106, content resources accessed, and interactions with other user devices 106. This data may be stored and processed by the user data server 114, to support user tracking and analysis features. For instance, in the professional training and educational contexts, the user data server 114 may store and analyze each user's training materials viewed, presentations attended, courses completed, interactions, evaluation results, and the like. The user data server 114 may also include a repository for user-generated material, such as evaluations and tests completed by users, and documents and assignments prepared by users. In the context of media distribution and interactive gaming, the user data server 114 may store and process resource access data for multiple users (e.g., content titles accessed, access times, data usage amounts, gaming histories, user devices and device types, etc.).

Administrator server 116 may include hardware and software components to initiate various administrative functions at the content management server 102 and other components within the content distribution network 100. For example, the administrator server 116 may monitor device status and performance for the various servers, data stores, and/or user devices 106 in the content distribution network 100. When necessary, the administrator server 116 may add or remove devices from the network 100, and perform device maintenance such as providing software updates to the devices in the network 100. Various administrative tools on the administrator server 116 may allow authorized users to set user access permissions to various content resources, monitor resource usage by users and devices 106, and perform analyses and generate reports on specific network users and/or devices (e.g., resource usage tracking reports, training evaluations, etc.).

The content distribution network 100 may include one or more communication networks 120. Although only a single network 120 is identified in FIG. 1, the content distribution network 100 may include any number of different communication networks between any of the computer servers and devices shown in FIG. 1 and/or other devices described herein. Communication networks 120 may enable communication between the various computing devices, servers, and other components of the content distribution network 100. As discussed below, various implementations of content distribution networks 100 may employ different types of networks 120, for example, computer networks, telecommunications networks, wireless networks, and/or any combination of these and/or other networks.

The content distribution network 100 may include one or several navigation systems or features including, for example, the Global Positioning System (“GPS”), GALILEO (e.g., Europe's global positioning system), or the like, or location systems or features including, for example, one or several transceivers that can determine location of the one or several components of the content distribution network 100 via, for example, triangulation. All of these are depicted as navigation system 122.

In some embodiments, navigation system 122 can include or several features that can communicate with one or several components of the content distribution network 100 including, for example, with one or several of the user devices 106 and/or with one or several of the supervisor devices 110. In some embodiments, this communication can include the transmission of a signal from the navigation system 122 which signal is received by one or several components of the content distribution network 100 and can be used to determine the location of the one or several components of the content distribution network 100.

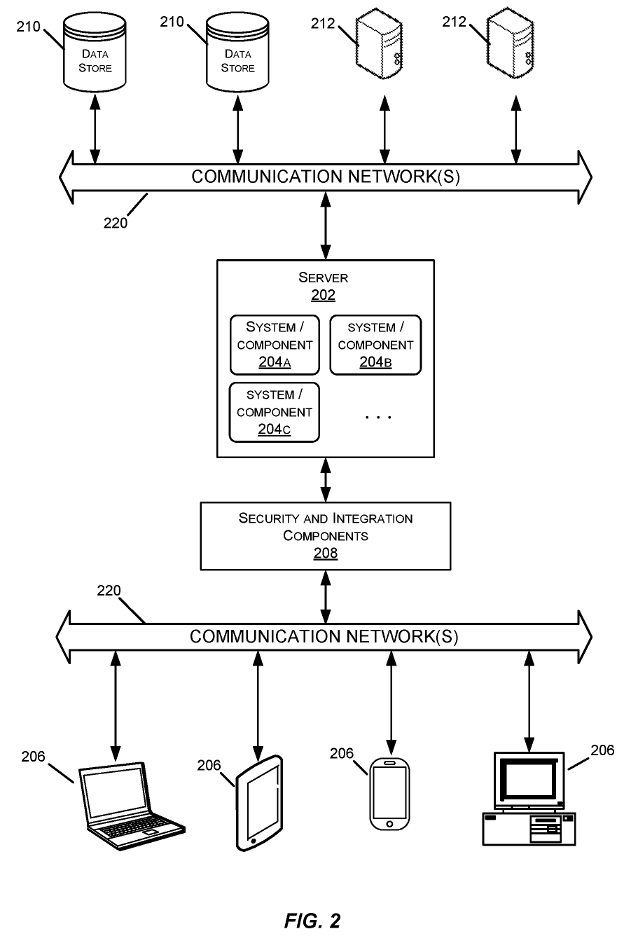

With reference to FIG. 2, an illustrative distributed computing environment 200 is shown including a computer server 202, four client computing devices 206, and other components that may implement certain embodiments and features described herein. In some embodiments, the server 202 may correspond to the content management server 102 discussed above in FIG. 1, and the client computing devices 206 may correspond to the user devices 106. However, the computing environment 200 illustrated in FIG. 2 may correspond to any other combination of devices and servers configured to implement a client-server model or other distributed computing architecture.

Client devices 206 may be configured to receive and execute client applications over one or more networks 220. Such client applications may be web browser based applications and/or standalone software applications, such as mobile device applications. Server 202 may be communicatively coupled with the client devices 206 via one or more communication networks 220. Client devices 206 may receive client applications from server 202 or from other application providers (e.g., public or private application stores). Server 202 may be configured to run one or more server software applications or services, for example, web-based or cloud-based services, to support content distribution and interaction with client devices 206. Users operating client devices 206 may in turn utilize one or more client applications (e.g., virtual client applications) to interact with server 202 to utilize the services provided by these components.

Various different subsystems and/or components 204 may be implemented on server 202. Users operating the client devices 206 may initiate one or more client applications to use services provided by these subsystems and components. The subsystems and components within the server 202 and client devices 206 may be implemented in hardware, firmware, software, or combinations thereof. Various different system configurations are possible in different distributed computing systems 200 and content distribution networks 100. The embodiment shown in FIG. 2 is thus one example of a distributed computing system and is not intended to be limiting.

Although exemplary computing environment 200 is shown with four client computing devices 206, any number of client computing devices may be supported. Other devices, such as specialized sensor devices, etc., may interact with client devices 206 and/or server 202.

As shown in FIG. 2, various security and integration components 208 may be used to send and manage communications between the server 202 and user devices 206 over one or more communication networks 220. The security and integration components 208 may include separate servers, such as web servers and/or authentication servers, and/or specialized networking components, such as firewalls, routers, gateways, load balancers, and the like. In some cases, the security and integration components 208 may correspond to a set of dedicated hardware and/or software operating at the same physical location and under the control of the same entities as server 202. For example, components 208 may include one or more dedicated web servers and network hardware in a datacenter or a cloud infrastructure. In other examples, the security and integration components 208 may correspond to separate hardware and software components which may be operated at a separate physical location and/or by a separate entity.

Security and integration components 208 may implement various security features for data transmission and storage, such as authenticating users and restricting access to unknown or unauthorized users. In various implementations, security and integration components 208 may provide, for example, a file-based integration scheme or a service-based integration scheme for transmitting data between the various devices in the content distribution network 100. Security and integration components 208 also may use secure data transmission protocols and/or encryption for data transfers, for example, File Transfer Protocol (FTP), Secure File Transfer Protocol (SFTP), and/or Pretty Good Privacy (PGP) encryption.

In some embodiments, one or more web services may be implemented within the security and integration components 208 and/or elsewhere within the content distribution network 100. Such web services, including cross-domain and/or cross-platform web services, may be developed for enterprise use in accordance with various web service standards, such as RESTful web services (i.e., services based on the Representation State Transfer (REST) architectural style and constraints), and/or web services designed in accordance with the Web Service Interoperability (WS-I) guidelines. Some web services may use the Secure Sockets Layer (SSL) or Transport Layer Security (TLS) protocol to provide secure connections between the server 202 and user devices 206. SSL or TLS may use HTTP or HTTPS to provide authentication and confidentiality. In other examples, web services may be implemented using REST over HTTPS with the OAuth open standard for authentication, or using the WS-Security standard which provides for secure SOAP (e.g., Simple Object Access Protocol) messages using Extensible Markup Language (XML) encryption. In other examples, the security and integration components 208 may include specialized hardware for providing secure web services. For example, security and integration components 208 may include secure network appliances having built-in features such as hardware-accelerated SSL and HTTPS, WS-Security, and firewalls. Such specialized hardware may be installed and configured in front of any web servers, so that any external devices may communicate directly with the specialized hardware.

Communication network(s) 220 may be any type of network familiar to those skilled in the art that can support data communications using any of a variety of commercially-available protocols, including without limitation, TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), Bluetooth®, Near Field Communication (NFC), and the like. Merely by way of example, network(s) 220 may be local area networks (LAN), such as one based on Ethernet, Token-Ring, and/or the like. Network(s) 220 also may be wide-area networks, such as the Internet. Networks 220 may include telecommunication networks such as a public switched telephone networks (PSTNs), or virtual networks such as an intranet or an extranet. Infrared and wireless networks (e.g., using the Institute of Electrical and Electronics (IEEE) 802.11 protocol suite or other wireless protocols) also may be included in networks 220.

Computing environment 200 also may include one or more data stores 210 and/or back-end servers 212. In certain examples, the data stores 210 may correspond to data store server(s) 104 discussed above in FIG. 1, and back-end servers 212 may correspond to the various back-end servers 112-116. Data stores 210 and servers 212 may reside in the same datacenter or may operate at a remote location from server 202. In some cases, one or more data stores 210 may reside on a non-transitory storage medium within the server 202. Other data stores 210 and back-end servers 212 may be remote from server 202 and configured to communicate with server 202 via one or more networks 220. In certain embodiments, data stores 210 and back-end servers 212 may reside in a storage-area network (SAN), or may use storage-as-a-service (STaaS) architectural model.

With reference to FIG. 3, an illustrative set of data stores and/or data store servers is shown, corresponding to the data store servers 104 of the content distribution network 100 discussed above in FIG. 1. One or more individual data stores 301-313 may reside in storage on a single computer server 104 (or a single server farm or cluster) under the control of a single entity, may be virtually implemented, or may reside on separate servers operated by different entities and/or at remote locations. In some embodiments, data stores 301-313 may be accessed by the content management server 102 and/or other devices and servers within the network 100 (e.g., user devices 106, supervisor devices 110, administrator servers 116, etc.). Access to one or more of the data stores 301-313 may be limited or denied based on the processes, user credentials, and/or devices attempting to interact with the data store.

The paragraphs below describe examples of specific data stores that may be implemented within some embodiments of a content distribution network 100. It should be understood that the below descriptions of data stores 301-313, including their functionality and types of data stored therein, are illustrative and non-limiting. Data stores server architecture, design, and the execution of specific data stores 301-313 may depend on the context, size, and functional requirements of a content distribution network 100. For example, in content distribution systems 100 used for professional training and educational purposes, separate databases or file-based storage systems may be implemented in data store server(s) 104 to store trainee and/or student data, trainer and/or professor data, training module data and content descriptions, training results, evaluation data, and the like. In contrast, in content distribution systems 100 used for media distribution from content providers to subscribers, separate data stores may be implemented in data stores server(s) 104 to store listings of available content titles and descriptions, content title usage statistics, subscriber profiles, account data, payment data, network usage statistics, etc.

A user profile data store 301, also referred to herein as a user profile database 301, may include information relating to the end users within the content distribution network 100. This information may include user characteristics such as the user names, access credentials (e.g., logins and passwords), user preferences, and information relating to any previous user interactions within the content distribution network 100 (e.g., requested content, posted content, content modules completed, training scores or evaluations, other associated users, etc.). In some embodiments, this information can relate to one or several individual end users such as, for example, one or several students, teachers, administrators, or the like, and in some embodiments, this information can relate to one or several institutional end users such as, for example, one or several schools, groups of schools such as one or several school districts, one or several colleges, one or several universities, one or several training providers, or the like. In some embodiments, this information can identify one or several user memberships in one or several groups such as, for example, a student's membership in a university, school, program, grade, course, class, or the like.

The user profile database 301 can include information relating to a user's status, location, or the like. This information can identify, for example, a device a user is using, the location of that device, or the like. In some embodiments, this information can be generated based on any location detection technology including, for example, a navigation system 122, or the like.

Information relating to the user's status can identify, for example, logged-in status information that can indicate whether the user is presently logged-in to the content distribution network 100 and/or whether the log-in is active. In some embodiments, the information relating to the user's status can identify whether the user is currently accessing content and/or participating in an activity from the content distribution network 100.

In some embodiments, information relating to the user's status can identify, for example, one or several attributes of the user's interaction with the content distribution network 100, and/or content distributed by the content distribution network 100. This can include data identifying the user's interactions with the content distribution network 100, the content consumed by the user through the content distribution network 100, or the like. In some embodiments, this can include data identifying the type of information accessed through the content distribution network 100 and/or the type of activity performed by the user via the content distribution network 100, the lapsed time since the last time the user accessed content and/or participated in an activity from the content distribution network 100, or the like. In some embodiments, this information can relate to a content program comprising an aggregate of data, content, and/or activities, and can identify, for example, progress through the content program, or through the aggregate of data, content, and/or activities forming the content program. In some embodiments, this information can track, for example, the amount of time since participation in and/or completion of one or several types of activities, the amount of time since communication with one or several supervisors and/or supervisor devices 110, or the like.

In some embodiments in which the one or several end users are individuals, and specifically are students, the user profile database 301 can further include information relating to these students' academic and/or educational history. This information can identify one or several courses of study that the student has initiated, completed, and/or partially completed, as well as grades received in those courses of study. In some embodiments, the student's academic and/or educational history can further include information identifying student performance on one or several tests, quizzes, and/or assignments. In some embodiments, this information can be stored in a tier of memory that is not the fastest memory in the content delivery network 100. In some embodiments, this can comprise response information such as, for example, information identifying one or several questions or pieces of content and responses provided to the same. In some embodiments, this response information can be formed into one or several matrices “D” containing information for n users responding top items, these one or several matrices D are also referred to herein as the matrix D, the D matrix, the user matrix, and/or the response matrix. Thus, the matrix D can have n x p dimensions, and in some embodiments, the matrix D can identify whether user responses to items were correct or incorrect. In some embodiments, for example, the matrix D can include an entry “1” for an item when a user response to that item is correct and can otherwise include and entry “0”.

The user profile database 301 can include information relating to one or several student learning preferences. In some embodiments, for example, the user, also referred to herein as the student or the student-user, may have one or several preferred learning styles, one or several most effective learning styles, and/or the like. In some embodiments, the user's learning style can be any learning style describing how the user best learns or how the user prefers to learn. In one embodiment, these learning styles can include, for example, identification of the user as an auditory learner, as a visual learner, and/or as a tactile learner. In some embodiments, the data identifying one or several user learning styles can include data identifying a learning style based on the user's educational history such as, for example, identifying a user as an auditory learner when the user has received significantly higher grades and/or scores on assignments and/or in courses favorable to auditory learners. In some embodiments, this information can be stored in a tier of memory that is not the fastest memory in the content delivery network 100.

In some embodiments, the user profile data store 301 can further include information identifying one or several user skill levels. In some embodiments, these one or several user skill levels can identify a skill level determined based on past performance by the user interacting with the content delivery network 100, and in some embodiments, these one or several user skill levels can identify a predicted skill level determined based on past performance by the user interacting with the content delivery network 100 and one or several predictive models.

The user profile database 301 can further include information relating to one or several teachers and/or instructors who are responsible for organizing, presenting, and/or managing the presentation of information to the user. In some embodiments, user profile database 301 can include information identifying courses and/or subjects that have been taught by the teacher, data identifying courses and/or subjects currently taught by the teacher, and/or data identifying courses and/or subjects that will be taught by the teacher. In some embodiments, this can include information relating to one or several teaching styles of one or several teachers. In some embodiments, the user profile database 301 can further include information indicating past evaluations and/or evaluation reports received by the teacher. In some embodiments, the user profile database 301 can further include information relating to improvement suggestions received by the teacher, training received by the teacher, continuing education received by the teacher, and/or the like. In some embodiments, this information can be stored in a tier of memory that is not the fastest memory in the content delivery network 100.

An accounts data store 302, also referred to herein as an accounts database 302, may generate and store account data for different users in various roles within the content distribution network 100. For example, accounts may be created in an accounts data store 302 for individual end users, supervisors, administrator users, and entities such as companies or educational institutions. Account data may include account types, current account status, account characteristics, and any parameters, limits, restrictions associated with the accounts.

A content library data store 303, also referred to herein as a content library database 303, may include information describing the individual content items (or content resources or data packets) available via the content distribution network 100. In some embodiments, these data packets in the content library database 303 can be linked to from an object network, or specifically to form a Bayes Net content network or learning graph. In some embodiments, these data packets can be linked in the object network according to one or several prerequisite relationships that can, for example, identify the relative hierarchy and/or difficulty of the data objects. In some embodiments, this hierarchy of data objects can be generated by the content distribution network 100 according to user experience with the object network, and in some embodiments, this hierarchy of data objects can be generated based on one or several existing and/or external hierarchies such as, for example, a syllabus, a table of contents, or the like. In some embodiments, for example, the object network can correspond to a syllabus such that content for the syllabus is embodied in the object network.

In some embodiments, the content library data store 303 can comprise a syllabus, a schedule, or the like. In some embodiments, the syllabus or schedule can identify one or several tasks and/or events relevant to the user. In some embodiments, for example, when the user is a member of a group such as, a section or a class, these tasks and/or events relevant to the user can identify one or several assignments, quizzes, exams, or the like.

In some embodiments, the library data store 303 may include metadata, properties, and other characteristics associated with the content resources stored in the content server 112. Such data may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some embodiments, the library data store 303 may be configured to allow updating of content metadata or properties, and to allow the addition and/or removal of information relating to the content resources. For example, content relationships may be implemented as graph structures, which may be stored in the library data store 303 or in an additional store for use by selection algorithms along with the other metadata.

In some embodiments, the content library data store 303 can contain information used in evaluating responses received from users. In some embodiments, for example, a user can receive content from the content distribution network 100 and can, subsequent to receiving that content, provide a response to the received content. In some embodiments, for example, the received content can comprise one or several questions, prompts, or the like, and the response to the received content can comprise an answer to those one or several questions, prompts, or the like. In some embodiments, information, referred to herein as “comparative data,” from the content library data store 303 can be used to determine whether the responses are the correct and/or desired responses.

In some embodiments, the content library database 303 and/or the user profile database 301 can comprise an aggregation network also referred to herein as a content network or content aggregation network. The aggregation network can comprise a plurality of content aggregations that can be linked together by, for example: creation by common user; relation to a common subject, topic, skill, or the like; creation from a common set of source material such as source data packets; or the like. In some embodiments, the content aggregation can comprise a grouping of content comprising the presentation portion that can be provided to the user in the form of, for example, a flash card and an extraction portion that can comprise the desired response to the presentation portion such as for example, an answer to a flash card. In some embodiments, one or several content aggregations can be generated by the content distribution network 100 and can be related to one or several data packets they can be, for example, organized in object network. In some embodiments, the one or several content aggregations can be each created from content stored in one or several of the data packets.

In some embodiments, the content aggregations located in the content library database 303 and/or the user profile database 301 can be associated with a user-creator of those content aggregations. In some embodiments, access to content aggregations can vary based on, for example, whether a user created the content aggregations. In some embodiments, the content library database 303 and/or the user profile database 301 can comprise a database of content aggregations associated with a specific user, and in some embodiments, the content library database 303 and/or the user profile database 301 can comprise a plurality of databases of content aggregations that are each associated with a specific user. In some embodiments, these databases of content aggregations can include content aggregations created by their specific user and in some embodiments, these databases of content aggregations can further include content aggregations selected for inclusion by their specific user and/or a supervisor of that specific user. In some embodiments, these content aggregations can be arranged and/or linked in a hierarchical relationship similar to the data packets in the object network and/or linked to the object network in the object network or the tasks or skills associated with the data packets in the object network or the syllabus or schedule.

In some embodiments, the content aggregation network, and the content aggregations forming the content aggregation network, can be organized according to the object network and/or the hierarchical relationships embodied in the object network. In some embodiments, the content aggregation network, and/or the content aggregations forming the content aggregation network, can be organized according to one or several tasks identified in the syllabus, schedule or the like.

A pricing data store 304 may include pricing information and/or pricing structures for determining payment amounts for providing access to the content distribution network 100 and/or the individual content resources within the network 100. In some cases, pricing may be determined based on a user's access to the content distribution network 100, for example, a time-based subscription fee or pricing based on network usage. In other cases, pricing may be tied to specific content resources. Certain content resources may have associated pricing information, whereas other pricing determinations may be based on the resources accessed, the profiles and/or accounts of the user, and the desired level of access (e.g., duration of access, network speed, etc.). Additionally, the pricing data store 304 may include information relating to compilation pricing for groups of content resources, such as group prices and/or price structures for groupings of resources.

A license data store 305 may include information relating to licenses and/or licensing of the content resources within the content distribution network 100. For example, the license data store 305 may identify licenses and licensing terms for individual content resources and/or compilations of content resources in the content server 112, the rights holders for the content resources, and/or common or large-scale right holder information such as contact information for rights holders of content not included in the content server 112.

A content access data store 306 may include access rights and security information for the content distribution network 100 and specific content resources. For example, the content access data store 306 may include login information (e.g., user identifiers, logins, passwords, etc.) that can be verified during user login attempts to the network 100. The content access data store 306 also may be used to store assigned user roles and/or user levels of access. For example, a user's access level may correspond to the sets of content resources and/or the client or server applications that the user is permitted to access. Certain users may be permitted or denied access to certain applications and resources based on their subscription level, training program, course/grade level, etc. Certain users may have supervisory access over one or more end users, allowing the supervisor to access all or portions of the end user's content, activities, evaluations, etc. Additionally, certain users may have administrative access over some users and/or some applications in the content management network 100, allowing such users to add and remove user accounts, modify user access permissions, perform maintenance updates on software and servers, etc.

A source data store 307 may include information relating to the source of the content resources available via the content distribution network. For example, a source data store 307 may identify the authors and originating devices of content resources, previous pieces of data and/or groups of data originating from the same authors or originating devices and the like.

An evaluation data store 308 may include information used to direct the evaluation of users and content resources in the content management network 100. In some embodiments, the evaluation data store 308 may contain, for example, the analysis criteria and the analysis guidelines for evaluating users (e.g., trainees/students, gaming users, media content consumers, etc.) and/or for evaluating the content resources in the network 100. The evaluation data store 308 also may include information relating to evaluation processing tasks, for example, the identification of users and user devices 106 that have received certain content resources or accessed certain applications, the status of evaluations or evaluation histories for content resources, users, or applications, and the like. Evaluation criteria may be stored in the evaluation data store 308 including data and/or instructions in the form of one or several electronic rubrics or scoring guides for use in the evaluation of the content, users, or applications. The evaluation data store 308 also may include past evaluations and/or evaluation analyses for users, content, and applications, including relative rankings, characterizations, explanations, and the like.

A model data store 309, also referred to herein as a model database 309 can store information relating to one or several predictive models. In some embodiments, these can include one or several evidence models, risk models, skill models, or the like. In some embodiments, an evidence model can be a mathematically-based statistical model. The evidence model can be based on, for example, Item Response Theory (IRT), Bayesian Network (Bayes net), Performance Factor Analysis (PFA), or the like. The evidence model can, in some embodiments, be customizable to a user and/or to one or several content items. Specifically, one or several inputs relating to the user and/or to one or several content items can be inserted into the evidence model. These inputs can include, for example, one or several measures of user skill level, one or several measures of content item difficulty and/or skill level, or the like. The customized evidence model can then be used to predict the likelihood of the user providing desired or undesired responses to one or several of the content items.

In some embodiments, the risk models can include one or several models that can be used to calculate one or several model function values. In some embodiments, these one or several model function values can be used to calculate a risk probability, which risk probability can characterize the risk of a student-user failing to achieve a desired outcome such as, for example, failing to correctly respond to one or several data packets, failure to achieve a desired level of completion of a program, for example in a pre-defined time period, failure to achieve a desired learning outcome, or the like. In some embodiments, the risk probability can identify the risk of the student-user failing to complete 60% of the program.

In some embodiments, these models can include a plurality of model functions including, for example, a first model function, a second model function, a third model function, and a fourth model function. In some embodiments, some or all of the model functions can be associated with a portion of the program such as, for example a completion stage and/or completion status of the program. In one embodiment, for example, the first model function can be associated with a first completion status, the second model function can be associated with a second completion status, the third model function can be associated with a third completion status, and the fourth model function can be associated with a fourth completion status. In some embodiments, these completion statuses can be selected such that some or all of these completion statuses are less than the desired level of completion of the program. Specifically, in some embodiments, these completion statuses can be selected to all be at less than 60% completion of the program, and more specifically, in some embodiments, the first completion status can be at 20% completion of the program, the second completion status can be at 30% completion of the program, the third completion status can be at 40% completion of the program, and the fourth completion status can be at 50% completion of the program. Similarly, any desired number of model functions can be associated with any desired number of completion statuses.

In some embodiments, a model function can be selected from the plurality of model functions based on a user's progress through a program. In some embodiments, the user's progress can be compared to one or several status trigger thresholds, each of which status trigger thresholds can be associated with one or more of the model functions. If one of the status triggers is triggered by the user's progress, the corresponding one or several model functions can be selected.

The model functions can comprise a variety of types of models and/or functions. In some embodiments, each of the model functions outputs a function value that can be used in calculating a risk probability. This function value can be calculated by performing one or several mathematical operations on one or several values indicative of one or several user attributes and/or user parameters, also referred to herein as program status parameters. In some embodiments, each of the model functions can use the same program status parameters, and in some embodiments, the model functions can use different program status parameters. In some embodiments, the model functions use different program status parameters when at least one of the model functions uses at least one program status parameter that is not used by others of the model functions.

In some embodiments, a skill model can comprise a statistical model identifying a predictive skill level of one or several users. In some embodiments, this model can identify a single skill level of a user and/or a range of possible skill levels of a user. In some embodiments, this statistical model can identify a skill level of a student-user and an error value or error range associated with that skill level. In some embodiments, the error value can be associated with a confidence interval determined based on a confidence level. Thus, in some embodiments, as the number of user interactions with the content distribution network increases, the confidence level can increase and the error value can decrease such that the range identified by the error value about the predicted skill level is smaller.

A threshold database 310 can store one or several threshold values. These one or several threshold values can delineate between states or conditions. In one exemplary embodiment, for example, a threshold value can delineate between an acceptable user performance and an unacceptable user performance, between content appropriate for a user and content that is inappropriate for a user, between risk levels, or the like.

A prioritization database 311 can include data relating to one or several tasks and the prioritization of those one or several tasks with respect to each other. In some embodiments, the prioritization database 311 can be unique to a specific user, and in some embodiments, the prioritization database 311 can be applicable to a plurality of users. In some embodiments in which the prioritization database 311 is unique to a specific user, the prioritization database 311 can be a sub-database of the user profile database 301. In some embodiments, the prioritization database 311 can include information identifying a plurality of tasks and a relative prioritization amongst that plurality of tasks. In some embodiments, this prioritization can be static and in some embodiments, this prioritization can be dynamic in that the prioritization can change based on updates, for example, one or several of the tasks, the user profile database 301, or the like. In some embodiments, the prioritization database 311 can include information relating to tasks associated with a single course, group, class, or the like, and in some embodiments, the prioritization database 311 can include information relating to tasks associated with a plurality of courses, groups, classes, or the like.

A task can define an objective and/or outcome and can be associated with one or several data packets that can, for example, contribute to user attainment of the objective and/or outcome. In some embodiments, some or all of the data packets contained in the content library database 303 can be linked with one or several tasks stored in the prioritization database 311 such that a single task can be linked and/or associated with one or several data packets.

The prioritization database 311 can further include information relevant to the prioritization of one or several tasks and/or the prioritization database 311 can include information that can be used in determining the prioritization of one or several tasks. In some embodiments, this can include weight data which can identify a relative and/or absolute weight of a task. In some embodiments, for example, the weight data can identify the degree to which a task contributes to an outcome such as, for example, a score or a grade. In some embodiments, this weight data can specify the portion and/or percent of a grade of a class, section, course, or study that results from, and/or that is associated with the task.

The prioritization database 311 can further include information relevant to the composition of the task. In some embodiments, for example, this information, also referred to herein as a composition value, can identify one or several sub-tasks and/or content categories forming the tasks, as well as a contribution of each of those sub-tasks and/or content categories to the task. In some embodiments, the application of the weight data to the composition value can result in the identification of a contribution value for the task and/or for the one or several sub-tasks and/or content categories forming the task. This contribution value can identify the contribution of one, some, or all of the sub-tasks and/or content categories to the outcome such as, for example, the score or the grade.

The calendar data source 312, also referred to herein as the calendar database 312 can include timing information relevant to the tasks contained in the prioritization database 311. In some embodiments, this timing information can identify one or several dates by which the tasks should be completed, one or several event dates associated with the task such as, for example, one or several due dates, test dates, or the like, holiday information, or the like. In some embodiments, the calendar database 312 can further include any information provided to the user relating to other goals, commitments, or the like.

In addition to the illustrative data stores described above, data store server(s) 104 (e.g., database servers, file-based storage servers, etc.) may include one or more external data aggregators 313. External data aggregators 313 may include third-party data sources accessible to the content management network 100, but not maintained by the content management network 100. External data aggregators 313 may include any electronic information source relating to the users, content resources, or applications of the content distribution network 100. For example, external data aggregators 313 may be third-party data stores containing demographic data, education related data, consumer sales data, health related data, and the like. Illustrative external data aggregators 313 may include, for example, social networking web servers, public records data stores, learning management systems, educational institution servers, business servers, consumer sales data stores, medical record data stores, etc. Data retrieved from various external data aggregators 313 may be used to verify and update user account information, suggest user content, and perform user and content evaluations.

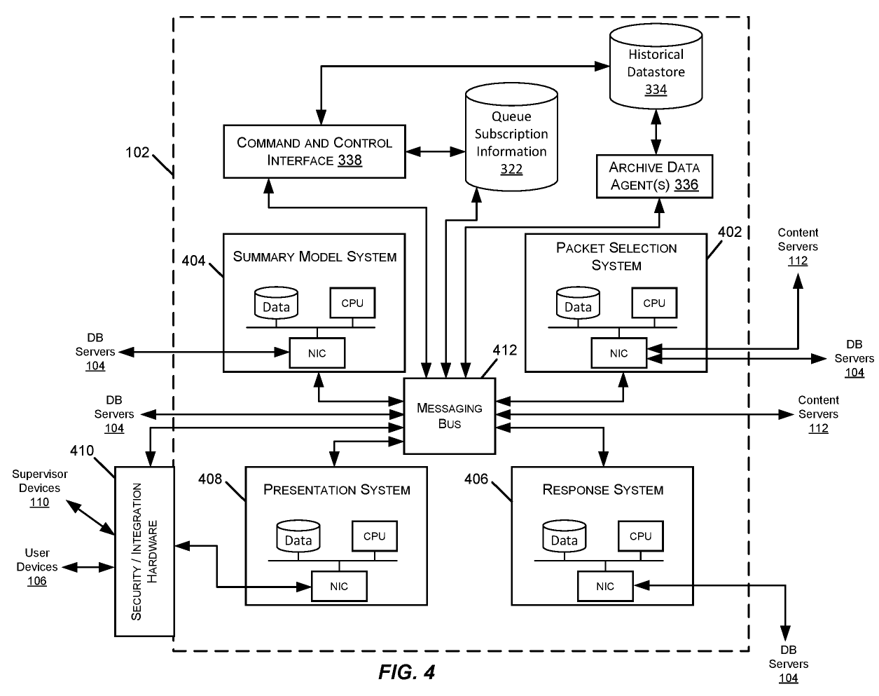

With reference now to FIG. 4, a block diagram is shown illustrating an embodiment of one or more content management servers 102 within a content distribution network 100. In such an embodiment, content management server 102 performs internal data gathering and processing of streamed content along with external data gathering and processing. Other embodiments could have either all external or all internal data gathering. This embodiment allows reporting timely information that might be of interest to the reporting party or other parties. In this embodiment, the content management server 102 can monitor gathered information from several sources to allow it to make timely business and/or processing decisions based upon that information. For example, reports of user actions and/or responses, as well as the status and/or results of one or several processing tasks could be gathered and reported to the content management server 102 from a number of sources.

Internally, the content management server 102 gathers information from one or more internal components 402-408. The internal components 402-408 gather and/or process information relating to such things as: content provided to users; content consumed by users; responses provided by users; user skill levels; content difficulty levels; next content for providing to users; etc. The internal components 402-408 can report the gathered and/or generated information in real-time, near real-time, or along another time line. To account for any delay in reporting information, a time stamp or staleness indicator can inform others of how timely the information was sampled. The content management server 102 can opt to allow third parties to use internally or externally gathered information that is aggregated within the server 102 by subscription to the content distribution network 100.

A command and control (CC) interface 338 configures the gathered input information to an output of data streams, also referred to herein as content streams. APIs for accepting gathered information and providing data streams are provided to third parties external to the server 102 who want to subscribe to data streams. The server 102 or a third party can design as yet undefined APIs using the CC interface 338. The server 102 can also define authorization and authentication parameters using the CC interface 338 such as authentication, authorization, login, and/or data encryption. CC information is passed to the internal components 402-408 and/or other components of the content distribution network 100 through a channel separate from the gathered information or data stream in this embodiment, but other embodiments could embed CC information in these communication channels. The CC information allows throttling information reporting frequency, specifying formats for information and data streams, deactivation of one or several internal components 402-408 and/or other components of the content distribution network 100, updating authentication and authorization, etc.

The various data streams that are available can be researched and explored through the CC interface 338. Those data stream selections for a particular subscriber, which can be one or several of the internal components 402-408 and/or other components of the content distribution network 100, are stored in the queue subscription information database 322. The server 102 and/or the CC interface 338 then routes selected data streams to processing subscribers that have selected delivery of a given data stream. Additionally, the server 102 also supports historical queries of the various data streams that are stored in an historical data store 334 as gathered by an archive data agent 336. Through the CC interface 338 various data streams can be selected for archiving into the historical data store 334.

Components of the content distribution network 100 outside of the server 102 can also gather information that is reported to the server 102 in real-time, near real-time, or along another time line. There is a defined API between those components and the server 102. Each type of information or variable collected by server 102 falls within a defined API or multiple APIs. In some cases, the CC interface 338 is used to define additional variables to modify an API that might be of use to processing subscribers. The additional variables can be passed to all processing subscribes or just a subset. For example, a component of the content distribution network 100 outside of the server 102 may report a user response, but define an identifier of that user as a private variable that would not be passed to processing subscribers lacking access to that user and/or authorization to receive that user data. Processing subscribers having access to that user and/or authorization to receive that user data would receive the subscriber identifier along with the response reported to that component. Encryption and/or unique addressing of data streams or sub-streams can be used to hide the private variables within the messaging queues.

The user devices 106 and/or supervisor devices 110 communicate with the server 102 through security and/or integration hardware 410. The communication with security and/or integration hardware 410 can be encrypted or not. For example, a socket using a TCP connection could be used. In addition to TCP, other transport layer protocols like Control Transmission Protocol (SCTP) and User Datagram Protocol (UDP) could be used in some embodiments to intake the gathered information. A protocol such as SSL could be used to protect the information over the TCP connection. Authentication and authorization can be performed to any user devices 106 and/or supervisor device interfacing to the server 102. The security and/or integration hardware 410 receives the information from one or several of the user devices 106 and/or the supervisor devices 110 by providing the API and any encryption, authorization, and/or authentication. In some cases, the security and/or integration hardware 410 reformats or rearranges this received information

The messaging bus 412, also referred to herein as a messaging queue or a messaging channel, can receive information from the internal components of the server 102 and/or components of the content distribution network 100 outside of the server 102 and distribute the gathered information as a data stream to any processing subscribers that have requested the data stream from the messaging queue 412. As indicated in FIG. 4, processing subscribers are indicated by a connector to the messaging bus 412, the connector having an arrow head pointing away from the messaging bus 412. In some examples, only data streams within the messaging queue 412 that a particular processing subscriber has subscribed to may be read by that processing subscriber if received at all. Gathered information sent to the messaging queue 412 is processed and returned in a data stream in a fraction of a second by the messaging queue 412. Various multicasting and routing techniques can be used to distribute a data stream from the messaging queue 412 that a number of processing subscribers have requested. Protocols such as Multicast or multiple Unicast could be used to distributed streams within the messaging queue 412. Additionally, transport layer protocols like TCP, SCTP and UDP could be used in various embodiments.

Through the CC interface 338, an external or internal processing subscriber can be assigned one or more data streams within the messaging queue 412. A data stream is a particular type of messages in a particular category. For example, a data stream can comprise all of the data reported to the messaging bus 412 by a designated set of components. One or more processing subscribers could subscribe and receive the data stream to process the information and make a decision and/or feed the output from the processing as gathered information fed back into the messaging queue 412. Through the CC interface 338 a developer can search the available data streams or specify a new data stream and its API. The new data stream might be determined by processing a number of existing data streams with a processing subscriber.

The CDN 110 has internal processing subscribers 402-408 that process assigned data streams to perform functions within the server 102. Internal processing subscribers 402-408 could perform functions such as providing content to a user, receiving a response from a user, determining the correctness of the received response, updating one or several models based on the correctness of the response, recommending new content for providing to one or several users, or the like. The internal processing subscribers 402-408 can decide filtering and weighting of records from the data stream. To the extent that decisions are made based upon analysis of the data stream, each data record is time stamped to reflect when the information was gathered such that additional credibility could be given to more recent results, for example. Other embodiments may filter out records in the data stream that are from an unreliable source or stale. For example, a particular contributor of information may prove to have less than optimal gathered information and that could be weighted very low or removed altogether.

Internal processing subscribers 402-408 may additionally process one or more data streams to provide different information to feed back into the messaging queue 412 to be part of a different data stream. For example, hundreds of user devices 106 could provide responses that are put into a data stream on the messaging queue 412. An internal processing subscriber 402-408 could receive the data stream and process it to determine the difficulty of one or several data packets provided to one or several users and supply this information back onto the messaging queue 412 for possible use by other internal and external processing subscribers.

As mentioned above, the CC interface 338 allows the CDN 110 to query historical messaging queue 412 information. An archive data agent 336 listens to the messaging queue 412 to store data streams in a historical database 334. The historical database 334 may store data streams for varying amounts of time and may not store all data streams. Different data streams may be stored for different amounts of time.

With regards to the components 402-408, the content management server(s) 102 may include various server hardware and software components that manage the content resources within the content distribution network 100 and provide interactive and adaptive content to users on various user devices 106. For example, content management server(s) 102 may provide instructions to and receive information from the other devices within the content distribution network 100, in order to manage and transmit content resources, user data, and server or client applications executing within the network 100.

A content management server 102 may include a packet selection system 402. The packet selection system 402 may be implemented using dedicated hardware within the content distribution network 100 (e.g., a packet selection server 402), or using designated hardware and software resources within a shared content management server 102. In some embodiments, the packet selection system 402 may adjust the selection and adaptive capabilities of content resources to match the needs and desires of the users receiving the content. For example, the packet selection system 402 may query various data stores and servers 104 to retrieve user information, such as user preferences and characteristics (e.g., from a user profile data store 301), user access restrictions to content recourses (e.g., from a content access data store 306), previous user results and content evaluations (e.g., from an evaluation data store 308), and the like. Based on the retrieved information from data stores 104 and other data sources, the packet selection system 402 may modify content resources for individual users.

In some embodiments, the packet selection system 402 can include a recommendation engine also referred to herein as an adaptive recommendation engine (not shown). In some embodiments, the recommendation engine can select one or several pieces of content, also referred to herein as data packets, for providing to a user. These data packets can be selected based on, for example, the information retrieved from the database server 104 including, for example, the user profile database 301, the content library database 303, the model database 309, or the like. In some embodiments, these one or several data packets can be adaptively selected and/or selected according to one or several selection rules. In one embodiment, for example, the recommendation engine can retrieve information from the user profile database 301 identifying, for example, a skill level of the user. The recommendation engine can further retrieve information from the content library database 303 identifying, for example, potential data packets for providing to the user and the difficulty of those data packets and/or the skill level associated with those data packets.

The recommendation engine can identify one or several potential data packets for providing and/or one or several data packets for providing to the user based on, for example, one or several rules, models, predictions, or the like. The recommendation engine can use the skill level of the user to generate a prediction of the likelihood of one or several users providing a desired response to some or all of the potential data packets. In some embodiments, the recommendation engine can pair one or several data packets with selection criteria that may be used to determine which packet should be delivered to a user based on one or several received responses from that student-user. In some embodiments, one or several data packets can be eliminated from the pool of potential data packets if the prediction indicates either too high a likelihood of a desired response or too low a likelihood of a desired response. In some embodiments, the recommendation engine can then apply one or several selection criteria to the remaining potential data packets to select a data packet for providing to the user. These one or several selection criteria can be based on, for example, criteria relating to a desired estimated time for receipt of response to the data packet, one or several content parameters, one or several assignment parameters, or the like.

A content management server 102 also may include a summary model system 404. The summary model system 404 may be implemented using dedicated hardware within the content distribution network 100 (e.g., a summary model server 404), or using designated hardware and software resources within a shared content management server 102. In some embodiments, the summary model system 404 may monitor the progress of users through various types of content resources and groups, such as media compilations, courses, or curriculums in training or educational contexts, interactive gaming environments, and the like. For example, the summary model system 404 may query one or more databases and/or data store servers 104 to retrieve user data such as associated content compilations or programs, content completion status, user goals, results, and the like.

A content management server 102 also may include a response system 406, which can include, in some embodiments, a response processor. The response system 406 may be implemented using dedicated hardware within the content distribution network 100 (e.g., a response server 406), or using designated hardware and software resources within a shared content management server 102. The response system 406 may be configured to receive and analyze information from user devices 106. For example, various ratings of content resources submitted by users may be compiled and analyzed, and then stored in a data store (e.g., a content library data store 303 and/or evaluation data store 308) associated with the content. In some embodiments, the response server 406 may analyze the information to determine the effectiveness or appropriateness of content resources with, for example, a subject matter, an age group, a skill level, or the like. In some embodiments, the response system 406 may provide updates to the packet selection system 402 or the summary model system 404, with the attributes of one or more content resources or groups of resources within the network 100. The response system 406 also may receive and analyze user evaluation data from user devices 106, supervisor devices 110, and administrator servers 116, etc. For instance, response system 406 may receive, aggregate, and analyze user evaluation data for different types of users (e.g., end users, supervisors, administrators, etc.) in different contexts (e.g., media consumer ratings, trainee or student comprehension levels, teacher effectiveness levels, gamer skill levels, etc.).

In some embodiments, the response system 406 can be further configured to receive one or several responses from the user and analyze these one or several responses. In some embodiments, for example, the response system 406 can be configured to translate the one or several responses into one or several observables. As used herein, an observable is a characterization of a received response. In some embodiments, the translation of the one or several response into one or several observables can include determining whether the one or several response are correct responses, also referred to herein as desired responses, or are incorrect responses, also referred to herein as undesired responses. In some embodiments, the translation of the one or several response into one or several observables can include characterizing the degree to which one or several response are desired responses and/or undesired responses. In some embodiments, one or several values can be generated by the response system 406 to reflect user performance in responding to the one or several data packets. In some embodiments, these one or several values can comprise one or several scores for one or several responses and/or data packets.

A content management server 102 also may include a presentation system 408. The presentation system 408 may be implemented using dedicated hardware within the content distribution network 100 (e.g., a presentation server 408), or using designated hardware and software resources within a shared content management server 102. The presentation system 408 can include a presentation engine that can be, for example, a software module running on the content delivery system.

The presentation system 408, also referred to herein as the presentation module or the presentation engine, may receive content resources from the packet selection system 402 and/or from the summary model system 404, and provide the resources to user devices 106. The presentation system 408 may determine the appropriate presentation format for the content resources based on the user characteristics and preferences, and/or the device capabilities of user devices 106. If needed, the presentation system 408 may convert the content resources to the appropriate presentation format and/or compress the content before transmission. In some embodiments, the presentation system 408 may also determine the appropriate transmission media and communication protocols for transmission of the content resources.

In some embodiments, the presentation system 408 may include specialized security and integration hardware 410, along with corresponding software components to implement the appropriate security features content transmission and storage, to provide the supported network and client access models, and to support the performance and scalability requirements of the network 100. The security and integration layer 410 may include some or all of the security and integration components 208 discussed above in FIG. 2, and may control the transmission of content resources and other data, as well as the receipt of requests and content interactions, to and from the user devices 106, supervisor devices 110, administrator servers 116, and other devices in the network 100.

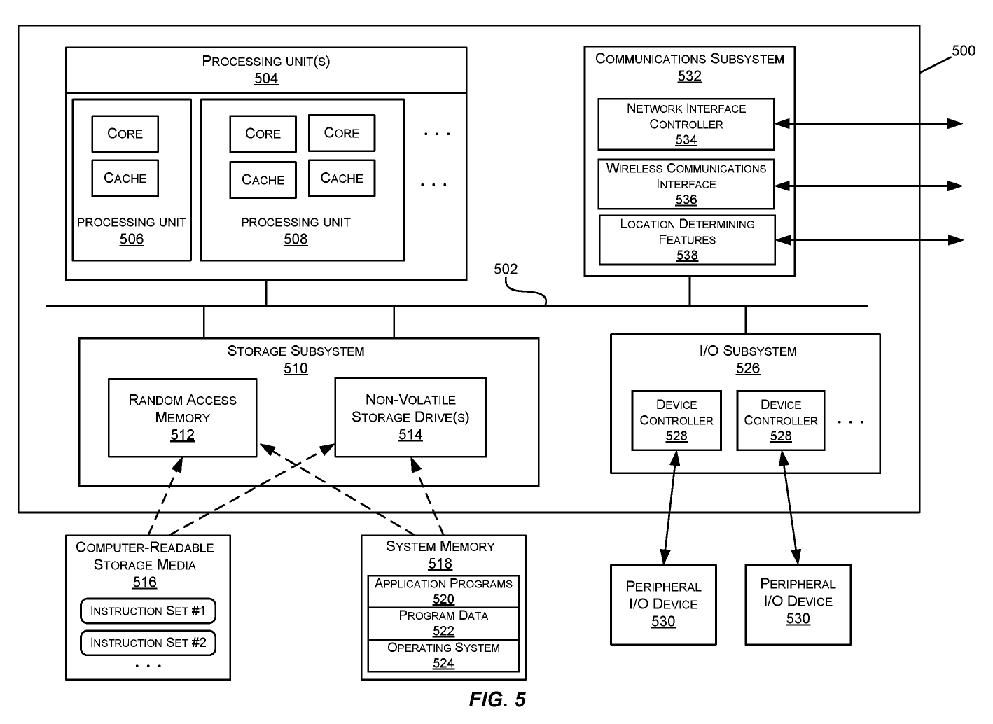

With reference now to FIG. 5, a block diagram of an illustrative computer system is shown. The system 500 may correspond to any of the computing devices or servers of the content distribution network 100 described above, or any other computing devices described herein, and specifically can include, for example, one or several of the user devices 106, the supervisor device 110, and/or any of the servers 102, 104, 108, 112, 114, 116. In this example, computer system 500 includes processing units 504 that communicate with a number of peripheral subsystems via a bus subsystem 502. These peripheral subsystems include, for example, a storage subsystem 510, an I/O subsystem 526, and a communications subsystem 532.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. Such architectures may include, for example, an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which may be implemented as one or more integrated circuits (e.g., a conventional microprocessor or microcontroller), controls the operation of computer system 500. One or more processors, including single core and/or multicore processors, may be included in processing unit 504. As shown in the figure, processing unit 504 may be implemented as one or more independent processing units 506 and/or 508 with single or multicore processors and processor caches included in each processing unit. In other embodiments, processing unit 504 may also be implemented as a quad-core processing unit or larger multicore designs (e.g., hexa-core processors, octo-core processors, ten-core processors, or greater.

Processing unit 504 may execute a variety of software processes embodied in program code, and may maintain multiple concurrently executing programs or processes. At any given time, some or all of the program code to be executed can be resident in processor(s) 504 and/or in storage subsystem 510. In some embodiments, computer system 500 may include one or more specialized processors, such as digital signal processors (DSPs), outboard processors, graphics processors, application-specific processors, and/or the like.

I/O subsystem 526 may include device controllers 528 for one or more user interface input devices and/or user interface output devices 530. User interface input and output devices 530 may be integral with the computer system 500 (e.g., integrated audio/video systems, and/or touchscreen displays), or may be separate peripheral devices which are attachable/detachable from the computer system 500. The I/O subsystem 526 may provide one or several outputs to a user by converting one or several electrical signals to user perceptible and/or interpretable form, and may receive one or several inputs from the user by generating one or several electrical signals based on one or several user-caused interactions with the I/O subsystem such as the depressing of a key or button, the moving of a mouse, the interaction with a touchscreen or trackpad, the interaction of a sound wave with a microphone, or the like.

Input devices 530 may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. Input devices 530 may also include three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additional input devices 530 may include, for example, motion sensing and/or gesture recognition devices that enable users to control and interact with an input device through a natural user interface using gestures and spoken commands, eye gesture recognition devices that detect eye activity from users and transform the eye gestures as input into an input device, voice recognition sensing devices that enable users to interact with voice recognition systems through voice commands, medical imaging input devices, MIDI keyboards, digital musical instruments, and the like.

Output devices 530 may include one or more display subsystems, indicator lights, or non-visual displays such as audio output devices, etc. Display subsystems may include, for example, cathode ray tube (CRT) displays, flat-panel devices, such as those using a liquid crystal display (LCD) or plasma display, light-emitting diode (LED) displays, projection devices, touch screens, and the like. In general, use of the term “output device” is intended to include all possible types of devices and mechanisms for outputting information from computer system 500 to a user or other computer. For example, output devices 530 may include, without limitation, a variety of display devices that visually convey text, graphics, and audio/video information such as monitors, printers, speakers, headphones, automotive navigation systems, plotters, voice output devices, and modems.

Computer system 500 may comprise one or more storage subsystems 510, comprising hardware and software components used for storing data and program instructions, such as system memory 518 and computer-readable storage media 516. The system memory 518 and/or computer-readable storage media 516 may store program instructions that are loadable and executable on processing units 504, as well as data generated during the execution of these programs.

Depending on the configuration and type of computer system 500, system memory 518 may be stored in volatile memory (such as random access memory (RAM) 512) and/or in non-volatile storage drives 514 (such as read-only memory (ROM), flash memory, etc.). The RAM 512 may contain data and/or program modules that are immediately accessible to and/or presently being operated and executed by processing units 504. In some implementations, system memory 518 may include multiple different types of memory, such as static random access memory (SRAM) or dynamic random access memory (DRAM). In some implementations, a basic input/output system (BIOS), containing the basic routines that help to transfer information between elements within computer system 500, such as during start-up, may typically be stored in the non-volatile storage drives 514. By way of example, and not limitation, system memory 518 may include application programs 520, such as client applications, Web browsers, mid-tier applications, server applications, etc., program data 522, and an operating system 524.

Storage subsystem 510 also may provide one or more tangible computer-readable storage media 516 for storing the basic programming and data constructs that provide the functionality of some embodiments. Software (programs, code modules, instructions) that when executed by a processor provide the functionality described herein may be stored in storage subsystem 510. These software modules or instructions may be executed by processing units 504. Storage subsystem 510 may also provide a repository for storing data used in accordance with the present invention.

Storage subsystem 510 may also include a computer-readable storage media reader that can further be connected to computer-readable storage media 516. Together and, optionally, in combination with system memory 518, computer-readable storage media 516 may comprehensively represent remote, local, fixed, and/or removable storage devices plus storage media for temporarily and/or more permanently containing, storing, transmitting, and retrieving computer-readable information.

Computer-readable storage media 516 containing program code, or portions of program code, may include any appropriate media known or used in the art, including storage media and communication media, such as, but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 500.

By way of example, computer-readable storage media 516 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 516 may include, but is not limited to, Zip® drives, flash memory cards, universal serial bus (USB) flash drives, secure digital (SD) cards, DVD disks, digital video tape, and the like. Computer-readable storage media 516 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Communications subsystem 532 may provide a communication interface from computer system 500 and external computing devices via one or more communication networks, including local area networks (LANs), wide area networks (WANs) (e.g., the Internet), and various wireless telecommunications networks. As illustrated in FIG. 5, the communications subsystem 532 may include, for example, one or more network interface controllers (NICs) 534, such as Ethernet cards, Asynchronous Transfer Mode NICs, Token Ring NICs, and the like, as well as one or more wireless communications interfaces 536, such as wireless network interface controllers (WNICs), wireless network adapters, and the like. As illustrated in FIG. 5, the communications subsystem 532 may include, for example, one or more location determining features 538 such as one or several navigation system features and/or receivers, and the like. Additionally and/or alternatively, the communications subsystem 532 may include one or more modems (telephone, satellite, cable, ISDN), synchronous or asynchronous digital subscriber line (DSL) units, FireWire® interfaces, USB® interfaces, and the like. Communications subsystem 536 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

The various physical components of the communications subsystem 532 may be detachable components coupled to the computer system 500 via a computer network, a FireWire® bus, or the like, and/or may be physically integrated onto a motherboard of the computer system 500. Communications subsystem 532 also may be implemented in whole or in part by software.

In some embodiments, communications subsystem 532 may also receive input communication in the form of structured and/or unstructured data feeds, event streams, event updates, and the like, on behalf of one or more users who may use or access computer system 500. For example, communications subsystem 532 may be configured to receive data feeds in real-time from users of social networks and/or other communication services, web feeds such as Rich Site Summary (RSS) feeds, and/or real-time updates from one or more third party information sources (e.g., external data source 313). Additionally, communications subsystem 532 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 532 may output such structured and/or unstructured data feeds, event streams, event updates, and the like to one or more data stores 104 that may be in communication with one or more streaming data source computers coupled to computer system 500.

Due to the ever-changing nature of computers and networks, the description of computer system 500 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

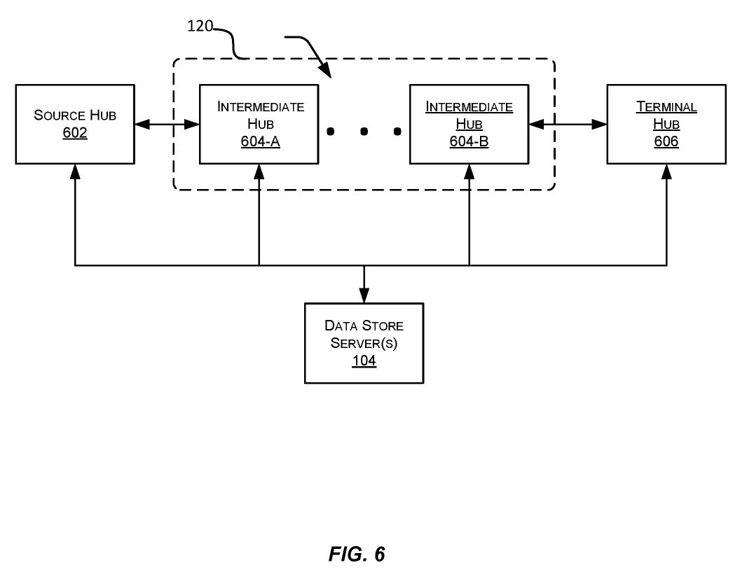

With reference now to FIG. 6, a block diagram illustrating one embodiment of the communication network is shown. Specifically, FIG. 6 depicts one hardware configuration in which messages are exchanged between a source hub 602 and a terminal hub 606 via the communication network 120 that can include one or several intermediate hubs 604. In some embodiments, the source hub 602 can be any one or several components of the content distribution network generating and initiating the sending of a message, and the terminal hub 606 can be any one or several components of the content distribution network 100 receiving and not re-sending the message. In some embodiments, for example, the source hub 602 can be one or several of the user device 106, the supervisor device 110, and/or the server 102, and the terminal hub 606 can likewise be one or several of the user device 106, the supervisor device 110, and/or the server 102. In some embodiments, the intermediate hubs 604 can include any computing device that receives the message and resends the message to a next node.

As seen in FIG. 6, in some embodiments, each of the hubs 602, 604, 606 can be communicatively connected with the data store 104. In such an embodiments, some or all of the hubs 602, 604, 606 can send information to the data store 104 identifying a received message and/or any sent or resent message. This information can, in some embodiments, be used to determine the completeness of any sent and/or received messages and/or to verify the accuracy and completeness of any message received by the terminal hub 606.

In some embodiments, the communication network 120 can be formed by the intermediate hubs 604. In some embodiments, the communication network 120 can comprise a single intermediate hub 604, and in some embodiments, the communication network 120 can comprise a plurality of intermediate hubs. In one embodiment, for example, and as depicted in FIG. 6, the communication network 120 includes a first intermediate hub 604-A and a second intermediate hub 604-B.

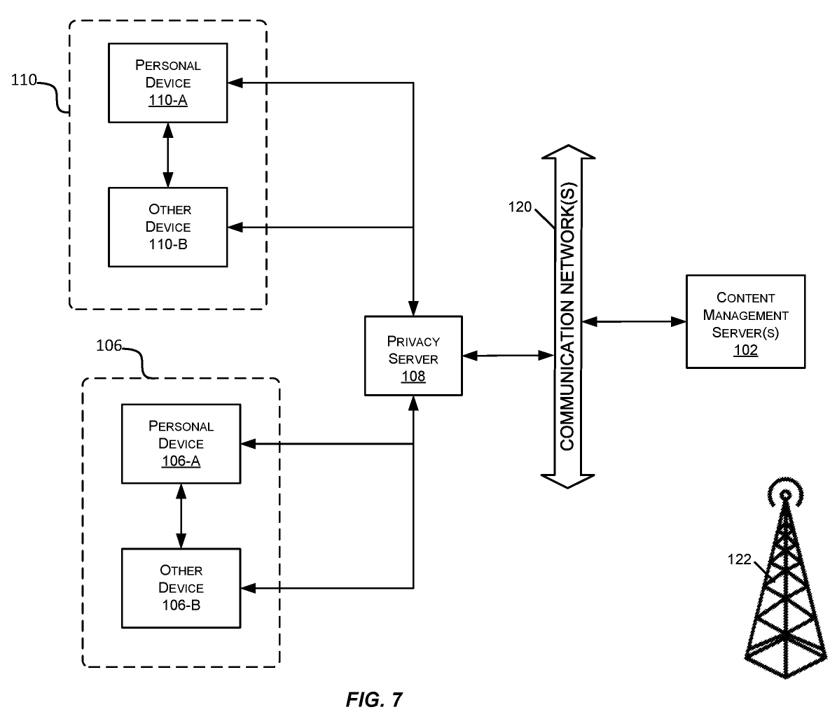

With reference now to FIG. 7, a block diagram illustrating one embodiment of user device 106 and supervisor device 110 communication is shown. In some embodiments, for example, a user may have multiple devices that can connect with the content distribution network 100 to send or receive information. In some embodiments, for example, a user may have a personal device such as a mobile device, a smartphone, a tablet, a smartwatch, a laptop, a PC, or the like. In some embodiments, the other device can be any computing device in addition to the personal device. This other device can include, for example, a laptop, a PC, a smartphone, a tablet, a smartwatch, or the like. In some embodiments, the other device differs from the personal device in that the personal device is registered as such within the content distribution network 100 and the other device is not registered as a personal device within the content distribution network 100.

Specifically with respect to FIG. 7 in view of the devices illustrated with FIG. 1, the user device 106 can include a personal user device 106-A and one or several other user devices 106-B. In some embodiments, one or both of the personal user device 106-A and the one or several other user devices 106-B can be communicatively connected to the content management server 102 and/or to the navigation system 122. Similarly, the supervisor device 110 can include a personal supervisor device 110-A and one or several other supervisor devices 110-B. In some embodiments, one or both of the personal supervisor device 110-A and the one or several other supervisor devices 110-B can be communicatively connected to the content management server 102 and/or to the navigation system 122.

In some embodiments, the content distribution network can send one or more alerts to one or more user devices 106 and/or one or more supervisor devices 110 via, for example, the communication network 120. In some embodiments, the receipt of the alert can result in the launching of an application within the receiving device, and in some embodiments, the alert can include a link that, when selected, launches the application or navigates a web-browser of the device of the selector of the link to page or portal associated with the alert.

In some embodiments, for example, the providing of this alert can include the identification of one or several user devices 106 and/or student-user accounts associated with the student-user and/or one or several supervisor devices 110 and/or supervisor-user accounts associated with the supervisor-user. After these one or several devices 106, 110 and/or accounts have been identified, the providing of this alert can include determining an active device of the devices 106, 110 based on determining which of the devices 106, 110 and/or accounts are actively being used, and then providing the alert to that active device.

Specifically, if the user is actively using one of the devices 106, 110 such as the other user device 106-B and the other supervisor device 110-B, and/or accounts, the alert can be provided to the user via that other device 106-B, 110-B, and/or account that is actively being used. If the user is not actively using another device 106-B, 110-B, and/or account, a personal device 106-A, 110-A device, such as a smart phone or tablet, can be identified and the alert can be provided to this personal device 106-A, 110-A. In some embodiments, the alert can include code to direct the default device to provide an indicator of the received alert such as, for example, an oral, tactile, or visual indicator of receipt of the alert.

In some embodiments, the recipient device 106, 110 of the alert can provide an indication of receipt of the alert. In some embodiments, the presentation of the alert can include the control of the I/O subsystem 526 to, for example, provide an oral, tactile, and/or visual indicator of the alert and/or of the receipt of the alert. In some embodiments, this can include controlling a screen of the supervisor device 110 to display the alert, data contained in alert and/or an indicator of the alert.

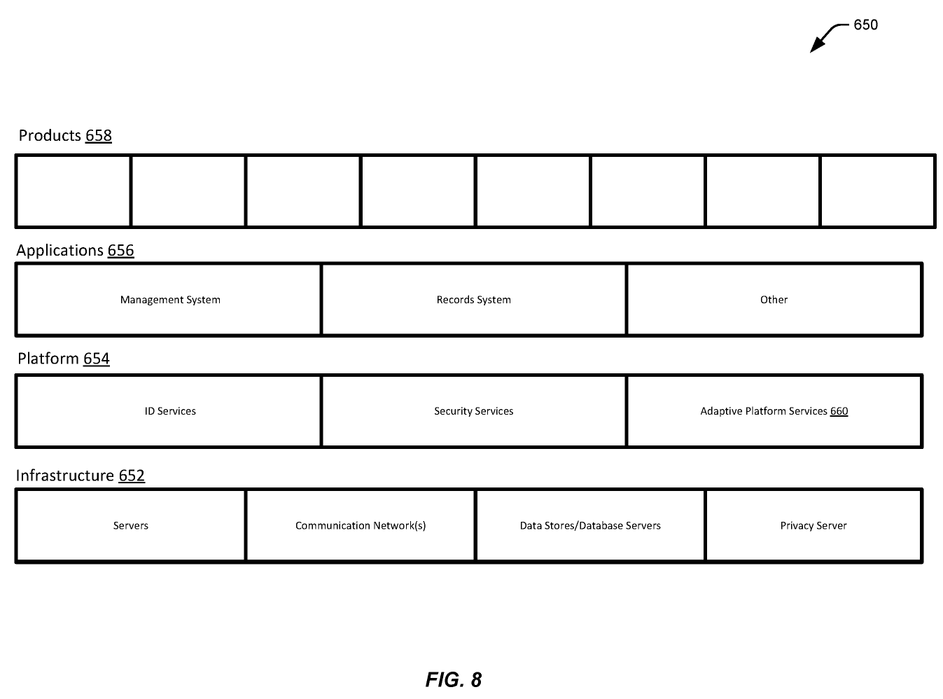

With reference now to FIG. 8, a schematic illustration of one embodiment of an application stack, and particularly of a stack 650 is shown. In some embodiments, the content distribution network 100 can comprise a portion of the stack 650 that can include an infrastructure layer 652, a platform layer 654, an applications layer 656, and a products layer 658. In some embodiments, the stack 650 can comprise some or all of the layers, hardware, and/or software to provide one or several desired functionalities and/or productions.

As depicted in FIG. 8, the infrastructure layer 652 can include one or several servers, communication networks, data stores, privacy servers, and the like. In some embodiments, the infrastructure layer can further include one or several user devices 106 and/or supervisor devices 110 connected as part of the content distribution network.

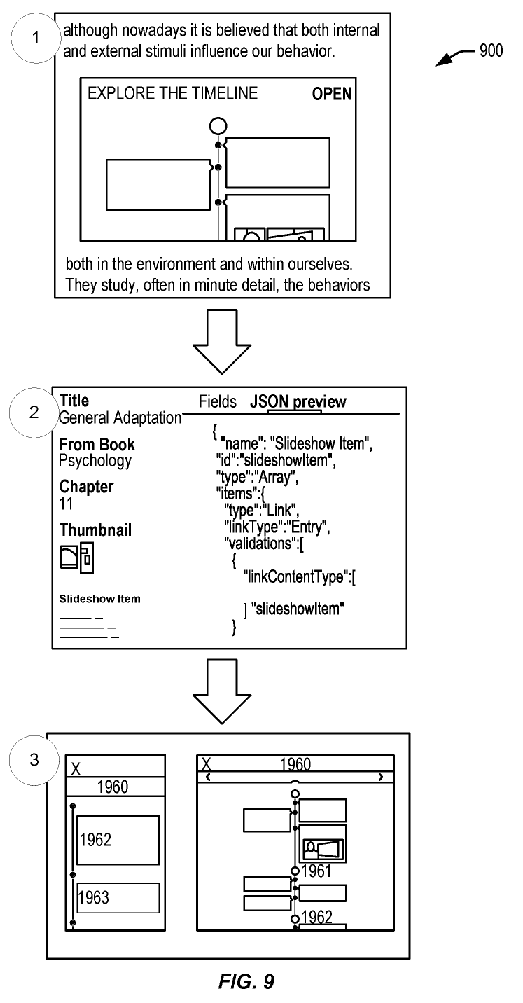

The platform layer can include one or several platform software programs, modules, and/or capabilities. These can include, for example, identification services, security services, and/or adaptive platform services 660. In some embodiments, the identification services can, for example, identify one or several users, components of the content distribution network 100, or the like. The security services can monitor the content distribution network for one or several security threats, breaches, viruses, malware, or the like. The adaptive platform services 660 can receive information from one or several components of the content distribution network 100 and can provide predictions, models, recommendations, or the like based on that received information. The functionality of the adaptive platform services 660 will be discussed in greater detail in FIGS. 9-11, below.

The applications layer 656 can include software or software modules upon or in which one or several product softwares or product software modules can operate. In some embodiments, the applications layer 656 can include, for example, a management system, record system, or the like. In some embodiments, the management system can include, for example, a Learning Management System (LMS), a Content Management System (CMS), or the like. The management system can be configured to control the delivery of one or several resources to a user and/or to receive one or several responses from the user. In some embodiments, the records system can include, for example, a virtual gradebook, a virtual counselor, or the like.

The products layer can include one or several software products and/or software module products. These software products and/or software module products can provide one or several services and/or functionalities to one or several users of the software products and/or software module products.

With reference now to FIG. 9, an illustrative flowchart of improved systems and methods that provide distribution and conversion of structured data is provided. In illustration 900, a process may be implemented in various distributed or consolidated systems described herein, including a content distribution network 100, the content management server 102, user devices 106, or supervisor devices 110.

At step 1, the content management server 102 may provide an editor tool that accepts content and automatically converts it to a platform agnostic format. In some examples, the platform agnostic format comprises a markup language. The data may be received from various sources, including content creators or other users operating user devices, via the editor tool. The content creators or other users operating user devices may access the editor tool to provide data. In some examples, the content management server 102 may provide editor tool to accept new content, including text, or receive data to adjust pre-existing templates including flashcards, timelines, assessments, or video galleries. The data received via the user interface of the content management server 102 may be incorporated with the pre-existing, unique templates of interactive structured data to create a markup document at step 2.

At step 2, the data received through the editor tool may can be converted to a structured data format using a platform agnostic set of rules and stored in a markup document or database. For example, once the editor tool at the content management server 102 accepts the data, the content management server 102 may create one or more structured content markup tags to correlate a template of interactive structured data with the received data from the editor tool. The structured content markup tag associated with a markup language may allow the markup tag to be rendered, parsed, and presented from a single markup document across multiple platforms. The structured content markup tag incorporated with the markup document may be read by a structured content application at a user device that corresponds with the protocols or platforms that are particular to that user device. The rendering process may be unique for the particular platform at the user device. As such, the markup document comprising the structured content markup tag may be transmitted to a plurality of platforms, and the individual platforms may render the markup document differently based at least in part on the structured content application executed at the user device.

At step 3, the structured content application implemented by the user device may receive the markup document and render the markup document for display at the user device via a user interface. The structured content application may read the markup document and parse the structured content markup tag from within the markup document. The structured content application may access a resource identification location (e.g., uniform resource identifiers, uniform resource location, etc.) associated with the structured content markup tag to determine corresponding data. The data may be stored at a database associated with the structured content markup tag. Using this data, the structured content application may render the markup document for display at the user device. The structured content application may also implement credential authentication or data formatting for a standardized look and feel across multiple platforms, as described herein.

The structured content application may correspond with a particular platform executed by the user device and the rendering of the markup document for the structured content application may be unique for each platform. For example, the correlation of the standard markup tag or structured content markup tag to the data from the editor tool enables a single markup document to be generated, but rendered differently by each structured content application. The process of packaging the data from the editor tool into the standard markup tag or structured content markup tag is relevant to generating the standardized look and feel across different platforms executing different structured content applications.

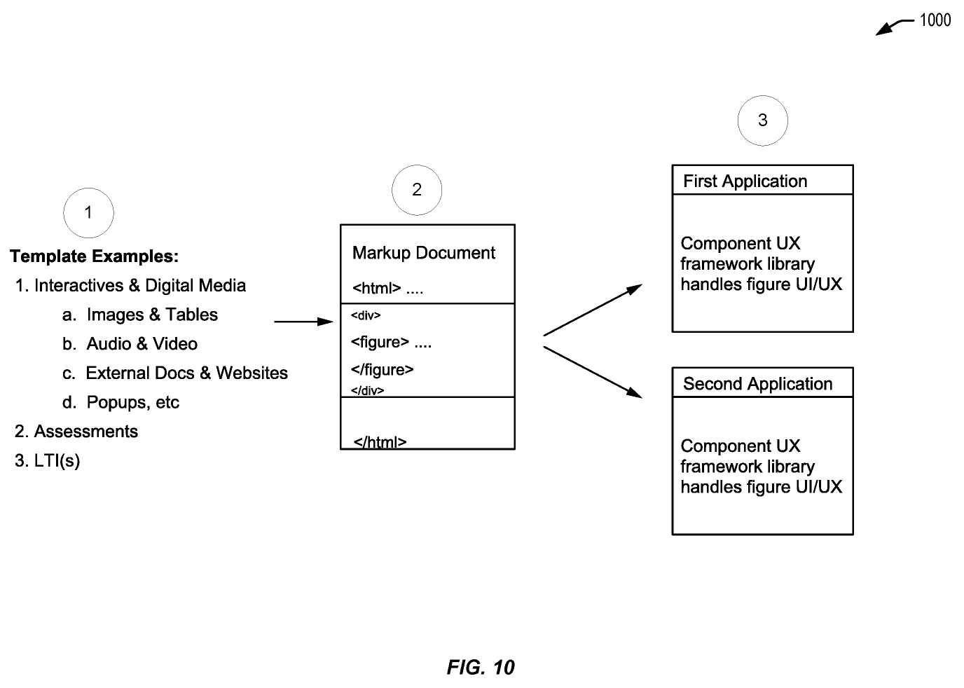

With reference now to FIG. 10, an illustrative flowchart of improved systems and methods that provide distribution and conversion of structured data is provided. In illustration 1000, a process may be implemented in various distributed or consolidated systems described herein, including a content distribution network 100, the content management server 102, user devices 106, or supervisor devices 110.

At step 1, the content management server 102 may provide an editor tool that allows a user to select one or more templates to customize for display at a user device. The content management server 102 may automatically convert the received selections into a platform agnostic format. In some examples, the template options may include interactive content features (e.g., flashcards, timelines, graphs, images, tables, audio, video, external documents, websites, pop-ups, etc.), digital media, and/or assessments.

In some examples, the generation of the markup document in a platform agnostic format may limit the use of certain features and data that are common in communication networks. For example, the markup document may avoid using embedded documents inside the markup document (e.g., iFrames, etc.), insertion of content from external sources (e.g., advertisements, notifications, etc.), object oriented programming languages used to create interactive effects within web browsers (e.g., JavaScript, etc.), object markup tags, embedded markup tags, and the like.

At step 2, the data received through the editor tool may be converted to a structured data format using a platform agnostic set of rules. For example, once the editor tool at the content management server accepts the data, the content management server may create one or more structured content markup tags to correlate the template selected through the editor tool with the received data from the editor tool.

At step 3, the markup document may be provided to a first structured content application at a first user device and a second structured content application at a second user device. The two structured content applications may receive the same markup document, but render the markup document differently based at least in part on the platform associated with the corresponding user device. In some examples, the first and second structured content applications may be different to correspond with the different platforms at the user devices. For example, the first structured content application they correspond with an iOS operating system while the second structured content application may correspond with a Windows (e.g., for desktops, etc.) or Firefox (e.g., for televisions, etc.) operating system.

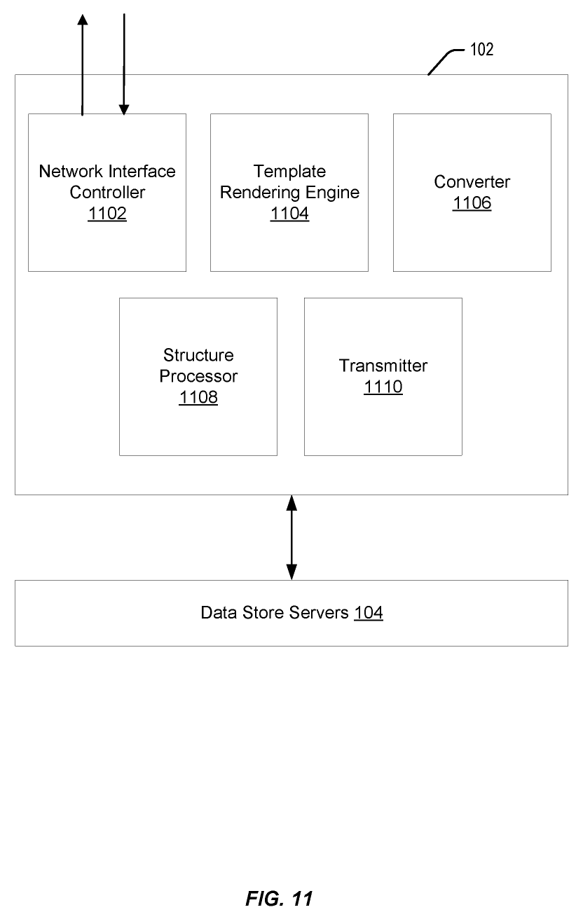

With reference now to FIG. 11, a block diagram is shown illustrating an embodiment of one or more content management servers 102 within a content distribution network 100. The content management server 102 may comprise one or more additional or alternative engines than embodiments previously discussed, including a network interface controller 1102, template rendering engine 1104, converter 1106, structure processor 1108, and transmitter 1110. In some examples, the content management servers 102 may correspond to any other combination of engines described throughout the application to implement features described herein.

The network interface controller 1102 may transmit and receive data using a specific physical layer and data link layer standard. The data may be received via an editor tool provided by the content management servers 102 and the editor tool may be accessible by one or more user devices. When the one or more user devices access the editor tool to provide data, the data from the editor tool may be received at the content management servers 102 via the network interface controller 1102.

The network interface controller 1102 may also transmit and receive other data, including a markup document transmitted to the one or more user devices. The markup document may be transmitted from the network interface controller 1102 at the content management servers 102 and received by a network interface controller at the user device. Each computer may implement the computer hardware component that connects the corresponding computer with the network interface controller to the communication network.

The content management servers 102 may also comprise a template rendering engine 1104. The template rendering engine 1104 may generate and provide the editor tool via a user interface. The template rendering engine 1104 may retrieve a second markup document that associates fields, images, or other graphical representations of the editor tool from a database and provide the second markup document via a communication network. For example, the user devices may access the editor tool using a web browser or other application used to access shared documents, which has been generated from the second markup document.

In some examples, the template rendering engine 1104 may begin rendering the markup documents before the document resources are received from the database. For example, the template rendering engine 1104 may provide a shell of the editor tool that may comprise one or more fields without additional objects (e.g., images, text, template selections, etc.). The user device may access the incomplete document to begin interactions. The template rendering engine 1104 may continue to provide the additional objects as it retrieves them from the database. The additional objects may be filled in as they are retrieved and transmitted via the communication network.

The content management servers 102 may also comprise a converter 1106. The converter 1106 may correlate input in a source language (e.g., English, etc.) from the fields of the editor tool with markup tags in a markup language. The particular field of the editor tool that received the input may correspond which markup tag to use. For example, a user device may provide input to a first field of the editor tool. The converter 1106 may assign the input of the first field to a data type and store the input in a database for future use, including use for the generation of the markup document.

The converter 1106 may determine which type of markup tags to correlate with input in the source language from fields of the editor tool. For example, the input may select a template of interactive structured data. Structured data may comprise information associated with academic or educational content that is received from a first user device, transformed to a structured format (e.g., template, assessment, timeline, flashcard, heading, description, educational material, etc.), and provided to a second user device in the structured format. The converter 1106 may associate that input with a structured content markup tag. In another example, the input may correspond with text or other content that is not structured. The converter 1106 may associate that input with a standard markup tag.

The content management servers 102 may also comprise a structure processor 1108. The structure processor 1108 may create the markup document with standard text data and structured data, including the standard markup tags and the structured content markup tags that were correlated by the converter 1106. The structure processor 1108 may follow a markup document format that is predetermined and stored with a structure definition table at the database. For example, the structure definition table may include titles (e.g., <TITLE> . . . </TITLE>), headings (e.g., <H2>Second level heading</H2>), anchors (e.g., <A NAME= . . . HREF= . . .> . . . </A>), paragraphs (e.g., <P>), highlighting (e.g., <HP1> . . . </HP1>), lists (e.g., <UL> <L1>list element <L1> second list element </UL>), and other tags that may be known in the art. In another example, the structure definition table may define the type of markup language used to create the network page rendered by the structured content application at the user device (e.g., <HTML>).

The structure processor 1108 may also be configured to update the markup document with more data from the editor tool or other sources. For example, the structure processor 1108 may receive a previously created markup document (e.g., from a database or other memory) and parse the markup document to find a location within the markup document to append the new data. As a sample illustration, a structure processor 1108 may receive data from a second field of the editor tool. The structure processor 1108 may parse the markup document and scanned the parsed markup document. The structure processor 1108 may determine a location of the markup document past the markup tags that define the markup language (e.g., <HTML>) and the input associated with the first field of the editor tool, and append the new data after the tag associated with the first field of the editor tool. A new tag may be added that correlates the second field of the editor tool with the markup language, as described throughout the disclosure.

The content management servers 102 may also comprise a transmitter 1110. The transmitter 1110 may be configured to store and transmit the markup document to the structured content application at one or more user devices via the network interface controller 1102. In some examples, the transmitter 1110 may maintain a user device location associated with the user device, including an Internet protocol (IP) address or other physical location accessible via a communication network of the structured content application. The transmitter 1110 may generate a message comprising the markup document and send the message via a network communication protocol to a network interface controller of one or more user devices.

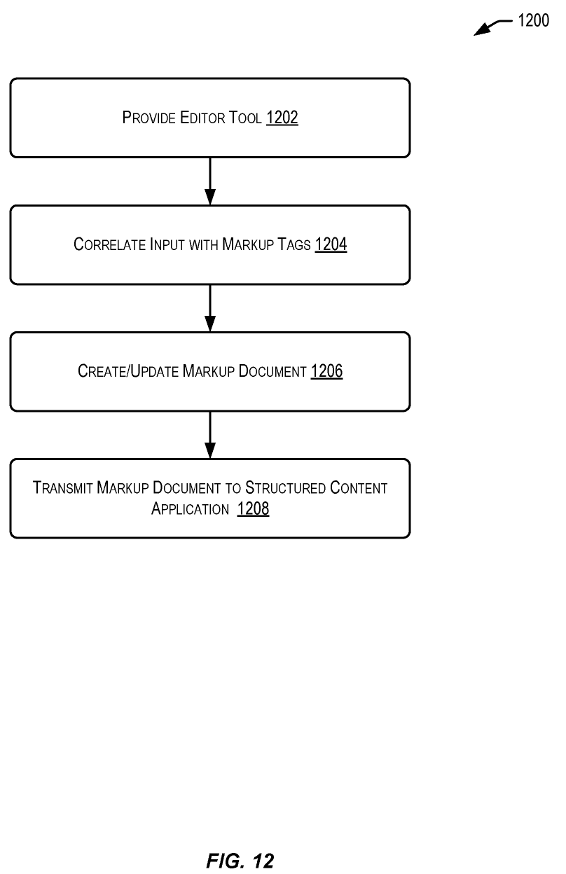

With reference now to FIG. 12, an illustrative flowchart related to the conversion of content to structured data is provided. In illustration 1200, a process may be implemented in various distributed or consolidated systems described herein, including a content distribution network 100, the content management server 102, user devices 106, or supervisor devices 110.

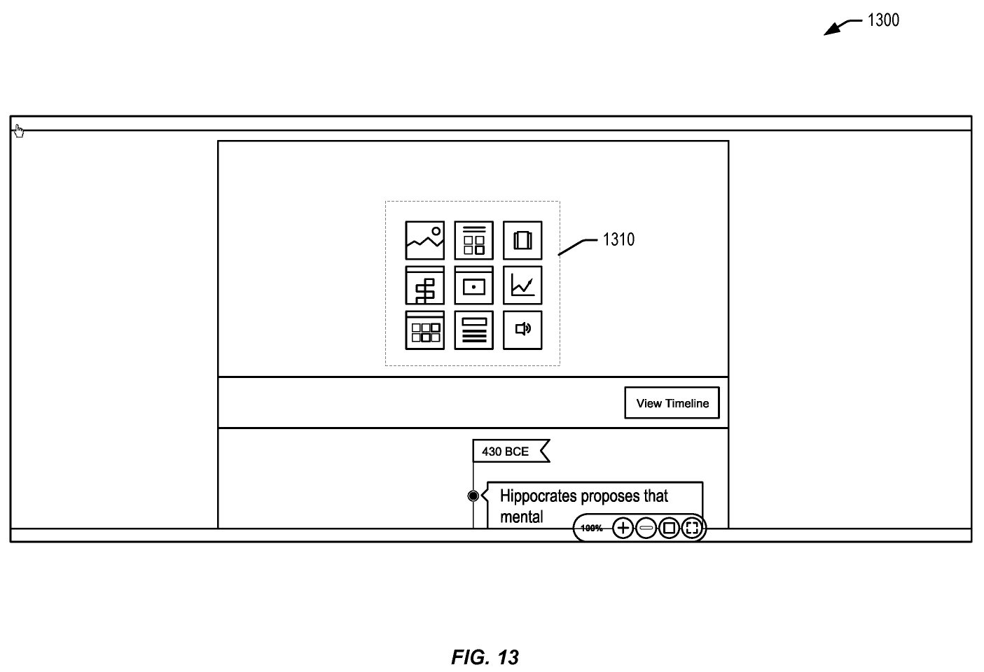

At 1202, an editor tool may be provided by the template rendering engine 1104 of the content management server 102. For example, the content management server 102 may provide, by one or more processors associated with the content management server 102, the editor tool. In some examples, the editor tool may comprise a first field for accepting text of the structured data in the second field for activating a template of interactive structured data. Illustrative examples of the editor tool are provided at FIGS. 13-18.

For example, with reference to FIG. 13, an illustrative user interface that displays an editor tool is provided. In illustration 1300, an editor tool may be accessed by a first user device. This first user device may help create the content in order for a second user device to view the content. The editor tool may comprise interactive elements 1310 that the first user may select at a user interface. Each of the interactive elements 1310 may correspond with a standard markup tag or a structured content markup tag in a markup document.

One or more of the interactive elements 1310 may also correspond with resource identification locations (e.g., uniform resource identifiers, uniform resource location, etc.) of the database. The resource identification location may point to the selected interactive elements when the markup document is rendered by the structured content application at the user device. In some examples, the resource identification location may comprise an absolute identifier that identifies a resource or other data that is accessible via a communication network. The resource identification location may comprise a simple string of characters or numbers and, in some examples, no other equivalents of resource identifiers may match the resource identification location.

Upon selection of each interactive element 1310, the first user may provide details to customize the interactive element for a particular context. When the first user provides text (e.g., header, caption, description, etc.), the text may correlate with a standard markup tag and the standard markup tag and text may be stored in a database. When the user selects an interactive element from a plurality of interactive elements 1310 (e.g., image, flash card, timeline, assessment, etc.), the editor tool may allow customization of the selected interactive element. The customization may alter a template of a pre-defined interactive element with data objects displayed at a user interface (e.g., frames, lines, positioning relative to an origin location on a webpage, etc.) with additional data from the first user device.

For example, the interactive elements 1310 may comprise an image data object. The image data object may comprise a plurality of pixels associated with an image file format (e.g., PNG, JPG, etc.) and/or one or more descriptions of the image in relation to the image file. The location of the image data object may be identified as input from the editor tool and/or predefined as an attribute of the interactive elements 1310.

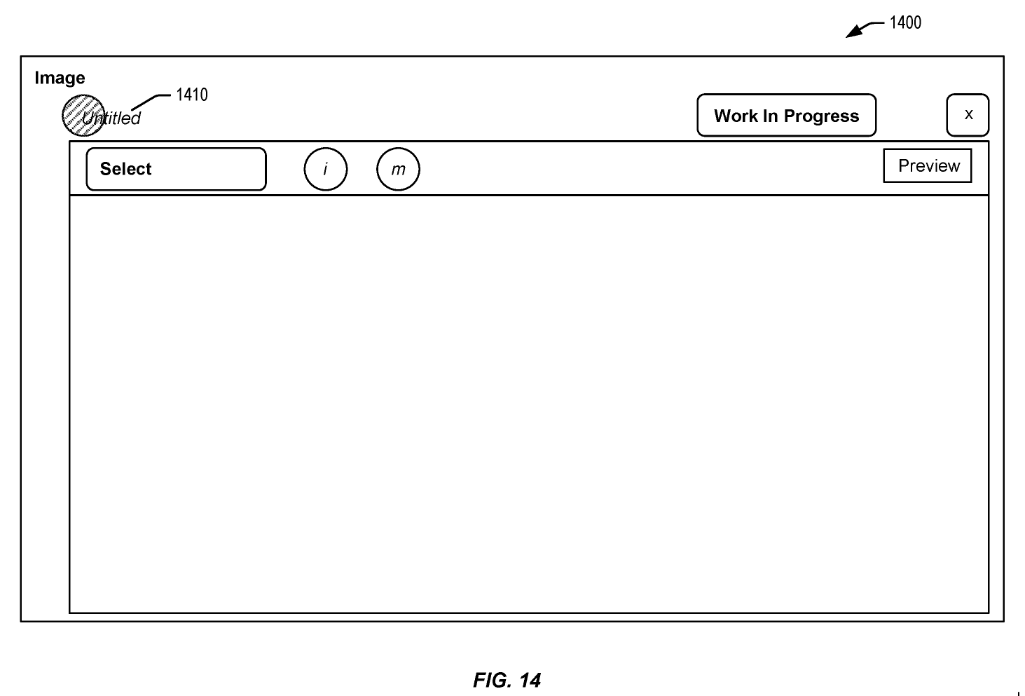

With reference to FIG. 14, a user interface is provided. In illustration 1400, the user interface provides an editor tool to define the image data object according to a template of interactive structured data. The interface may comprise a plurality of fields, including a first field 1410 for accepting text of the structured data. The user may interact with the editor tool via the user interface of the user device to provide the text. The text may include a title, description, heading, caption, or any other text that might be related image. At the first field 1410, the user may provide a title for the image and stored with the structure definition table.

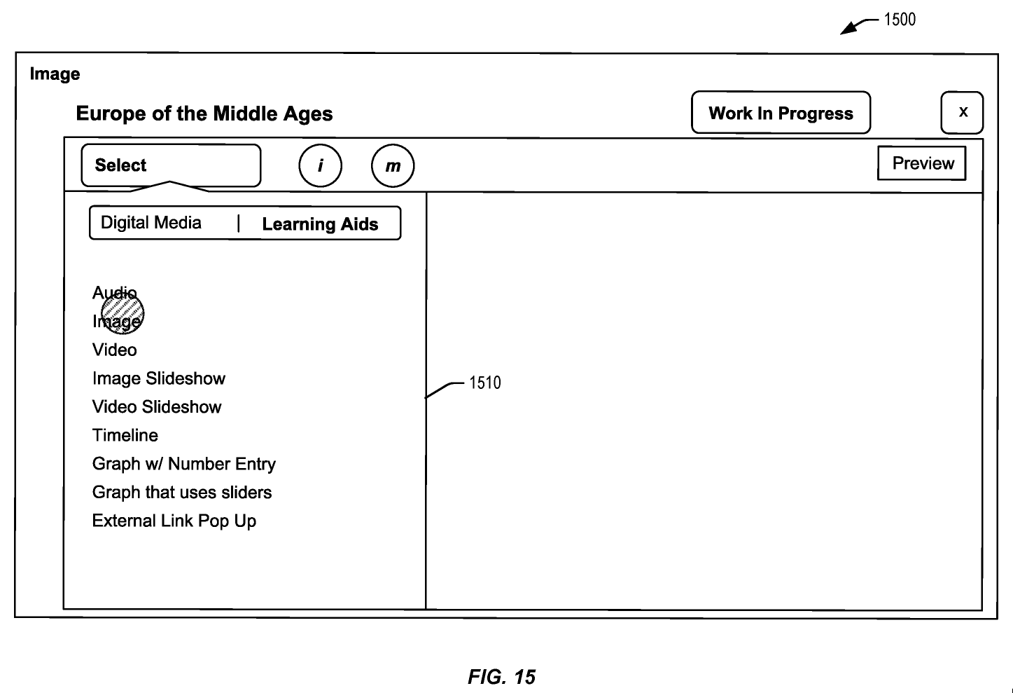

With reference to FIG. 15, a user interface is provided. In illustration 1500, a plurality of fields may be provided including a second field 1510 for activating a template of interactive structured data. The user may interact with the editor tool via the user interface of the user device that corresponds with the structured data. For example, the user may select “image” from a drop-down list of options for interactive structured data. Other interface objects may be implemented without diverting from the scope of the disclosure (e.g., radio buttons, checkboxes, text fields for accepting text, etc.).

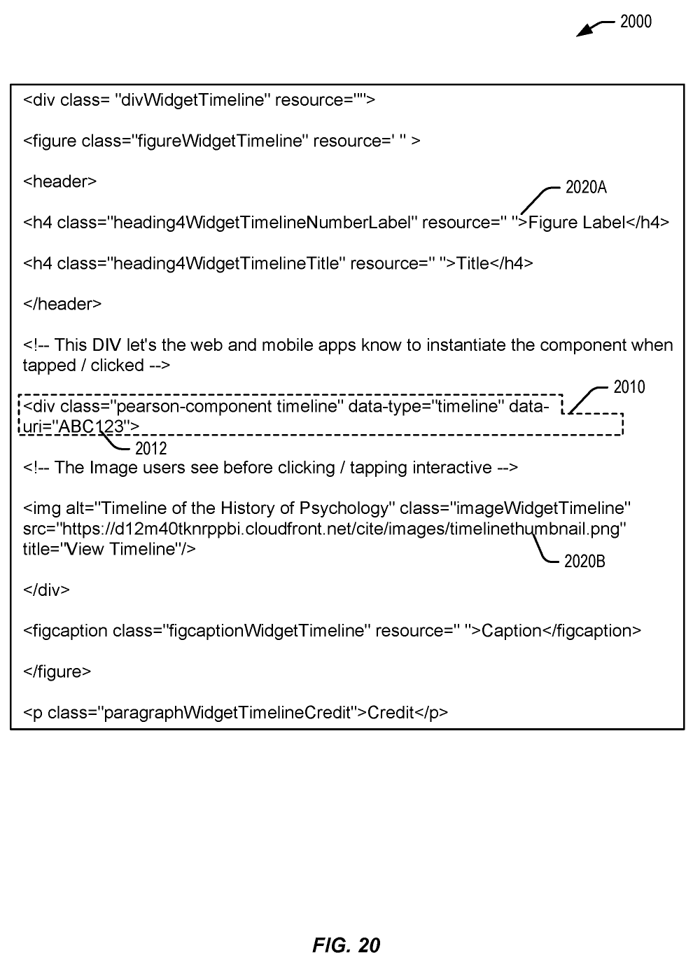

Each of the options in the drop-down list may correspond with a structured content markup tag. For example, for the image option, the structured content markup tag may comprise <DIV CLASS=“component_image” DATA_TYPE=“image” DATA_URI=“ABC123”>. Additional detail regarding the structured content markup tags are provided with FIG. 20.

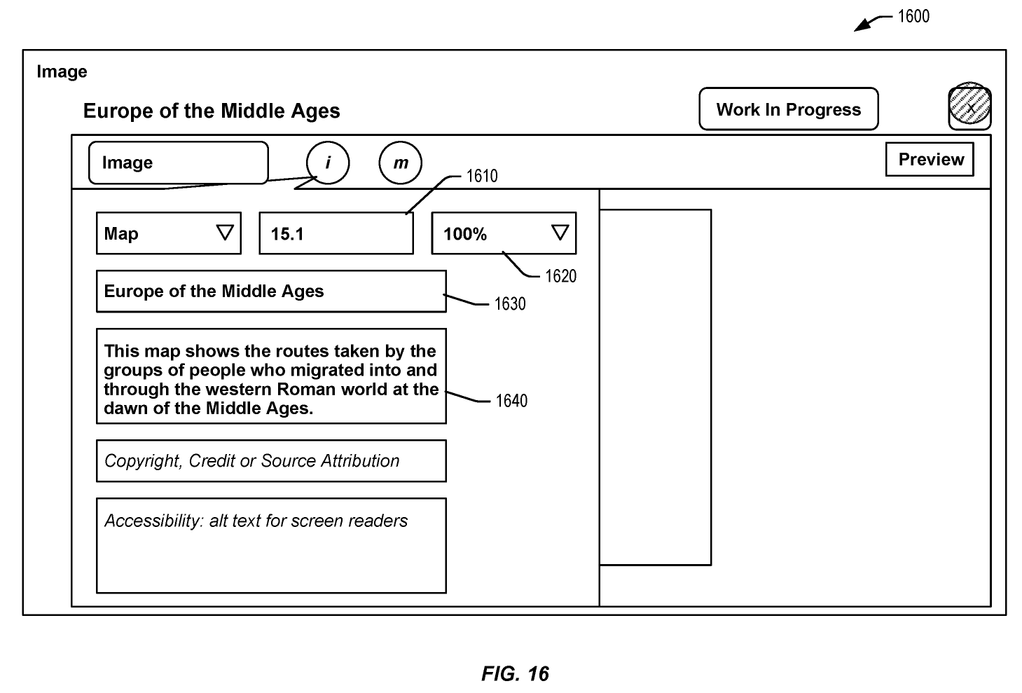

With reference to FIG. 16, a user interface is provided. In illustration 1600, a plurality of fields may be provided via the editor tool including alternative fields for accepting text. The fields may comprise footnote 1610, zoom 1620, caption 1630, and description 1640. The text corresponding with footnote 1610 includes “map 15.1” which might correlate with an image number in the overall text (e.g., chapter 15, first image in the chapter, etc.). The text corresponding with zoom 1620 may include “100%,” which may identify the relative size of the image that is generated for the user interface when the image is rendered and painted on the page by a structured content application executed by the user device. The text corresponding with caption 1630 includes “Europe in the Middle Ages,” which might help identify a summary of additional information associated with the image. The text corresponding with description 1640 includes “This map shows the routes taken by groups of people who migrated into and through the Western Roman world at the dawn of the Middle Ages.” The description 1640 may provide additional textual detail associated with the image.

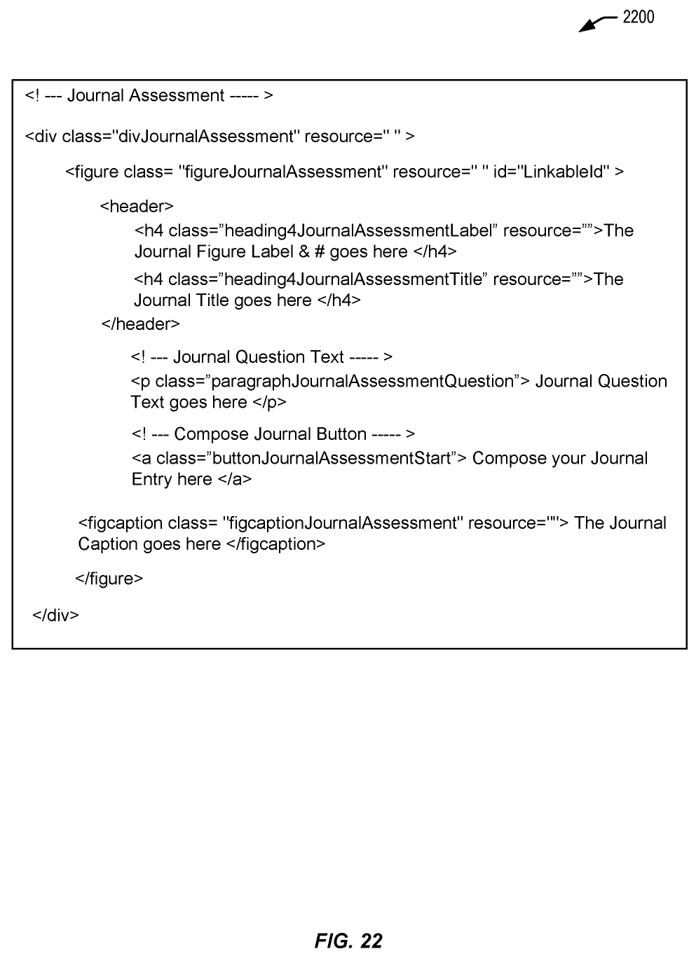

The fields in illustration 1600 may also correspond with eventual placement of the text by the structured content application the user device. For example, the selected “image” template of this example may place the text corresponding with each field according to a predetermined distance from location 0, 0 (e.g., upper left corner of the user interface) on the layout painted by the structured content application at the user device. The predetermined distance may be stored at a structure definition table of a database where values and rules are stored that define the templates. Additional details regarding the predetermined distances, values, and rules are provided with FIG. 22.

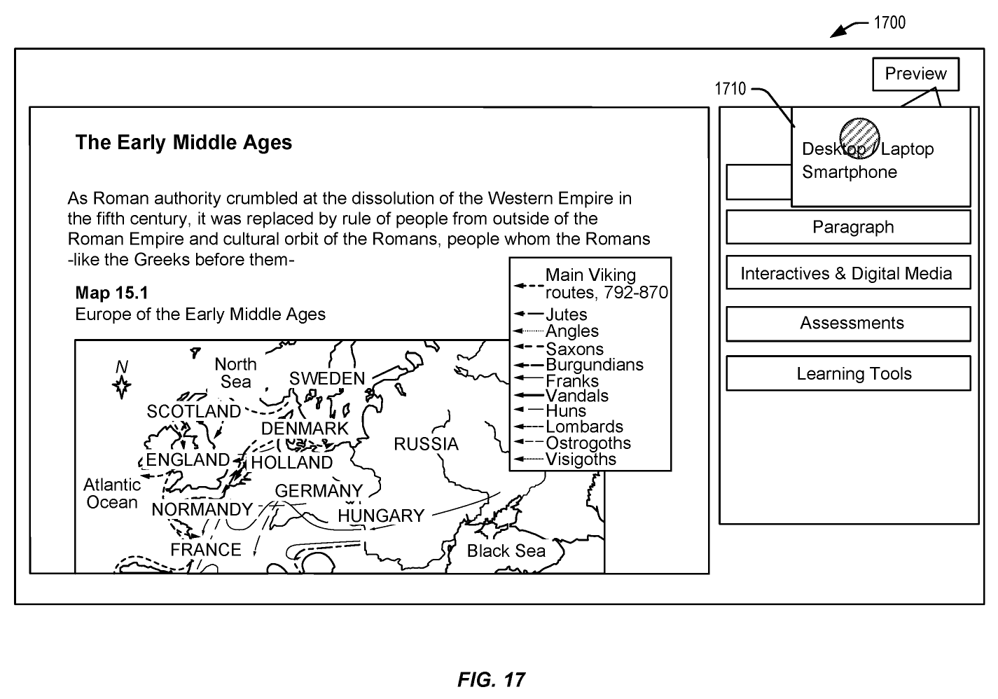

With reference to FIG. 17, a user interface is provided. In this illustration 1700, input from the plurality of fields may be provided as a preview of rendering performed by the structured content application prior to the structured content application rendering the markup document. For example, the content management server 102 may parse the markup document locally, without a transmission to the user device, and provide the rendered markup document at a user interface provided by the content management server 102.

In some examples, the content management server 102 may provide rendering options 1710 for providing the markup document on different platforms. As illustrated, the rendering options 1710 may include various types of user devices, including a desktop, smartphone, or a television. Each platform may affect the presentation at the user device. For example, a desktop rendering may provide multiple instances for interaction with data objects provided by the user interface, including interacting with the image of the map like increasing or decreasing the definition of the image (e.g., via the zoom option). In some examples, a smart phone user device may minimize the dimensions of the presentation area but rely on a powerful processor to increase the ability to interact with the data objects provided by the user interface. In some examples, a television user device may have a slow processor and interaction with the user device may be lessened or removed completely. By selecting one of the rendering options 1710, the user interface provided by the content management server 102 may present the title, description, image, and other data associated with the plurality of fields according to the rendering option selected for the particular user device in corresponding application.

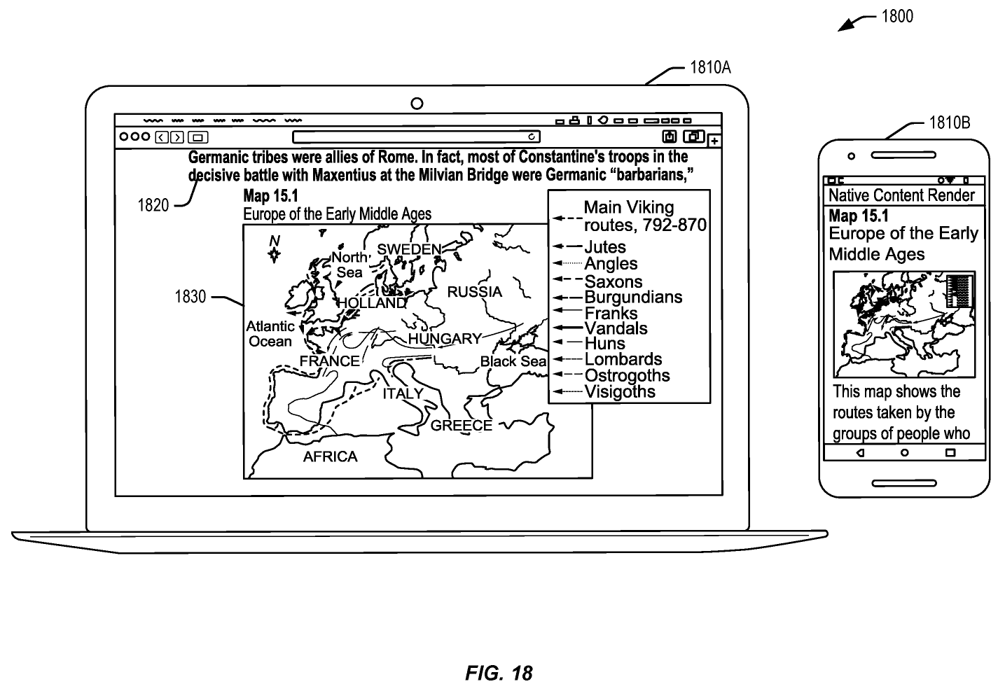

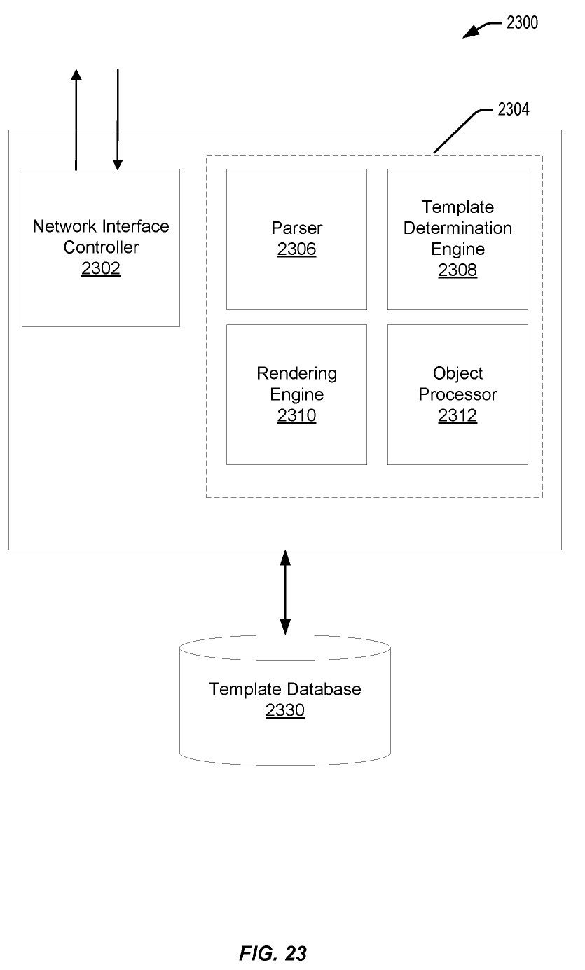

With reference to FIG. 18, plurality of user interfaces are provided. In illustration 1800, the markup document may be provided within the context of the structured content application at plurality of user devices 1810 (illustrated as desktop user device 1810A and smartphone user device 1810B). For example, the text and template with interactive structured data 1830 are provided with additional text 1820. The additional text 1820 may be received via the editor tool using a similar process as the generation of the interactive data element. The structure content applications (one at each user device 1810) may generate the object layout with the additional text 1820 and the text and template with interactive structured data 1830 using the method described as FIG. 23.

Returning to FIG. 13, other interactive elements 1310 are available for selection in addition to interactive images. For example, the interactive elements 1310 may comprise selections for flashcards, timelines, assessments, graphs, tables, video galleries, or other interactive features.

The interactive elements 1310 may comprise a flashcard. The flash card may comprise two dedicated data objects that are defined when the flash card template is generated through the editor tool. The first data object may correspond with a first side of the physical card and the second data object may correspond with a second side of the same physical card. In some examples, only one data object of the two representative sides may be displayed at a time. As an illustrative example, the first side of the data object may comprise an image of an apple and the second side of the data object may comprise the word “apple.” When the user interface provides the first side of the data object, a text field may also be provided with the user interface. The user may interact with the field to provide the word “apple” (e.g., type, speak, etc.). The user's response may be stored with the database. The image and corresponding text may also be stored with a database and determined upon the initial generation of the flash card from the interactive data elements 1310.

The interactive elements 1310 may comprise a timeline. The timeline may comprise one or more dates each with a data object and descriptions of events in relation to the dates within separate data objects. The location of each event data object eventually provided by the user interface of the structured content application may correspond with a relative time in history that the event occurred. The definition of the location of the event data may be determined by a timeline template according to the interactive element.

The interactive elements 1310 may comprise an assessment. The assessment may include questions and answers to present to one or more user devices as part of an assessment or test. For example, the assessment may provide a question at a first location of the user interface and, at a second location of the user interface, provide a field to receive an answer to the question. In some examples, the assessment may provide a video and pause the video after a predetermined amount of time. Once the video is paused, the assessment may provide a question to the user device that may be associated with the video, as well as a field for the answer. Various types of assessments are available without diverting from the essence of the disclosure.

The assessment may correspond with the template that is altered using the editor tool. Through the editor tool, a first user device may specify one or more questions and one or more corresponding answers for the assessment. The questions may comprise text or images. The answers may comprise the same, text or images, and may also correspond to fill in the blank text fields, radio buttons, checkboxes, or other data objects used in an assessment setting. When the components of the assessment are identified by the first user device, the assessment questions and corresponding answers may be stored with the database. In examples that implement a video, they first user device may upload or provide a link to the video and the assessment may access the video from the identified file or link.

The interactive elements 1310 may comprise a chart or graph. The chart or graph may include graphical axes and visual representations of data for presentation at a user interface. The user device, through the editor tool, may provide data associated with the axes and data contained within the chart or graph (e.g., growth over time, comparison of cost over time, etc.) and the template for the chart or graph may generate the final chart or graph according to the template definitions in the structure definition table of the database with the provided data.

The interactive elements 1310 may comprise audio or video. The audio or video may be uploaded by the user device and stored with the database via the editor tool. The user device may also provide headings, captions, or other descriptions associated with the audio or video, as with each of the other interactive elements 1310.

In some examples, the interactive elements 1310 may be associated with a time limit. For example, using the editor tool, the first user device may specify a time limit for answering a question in an assessment. A visual representation of the time corresponding with the assessment may be rendered with the template at the second user device. In some examples, the time may be paused, started, or stopped by the second user device. This predefined time limit may be stored with the customized template at the database as an attribute of the interactive element.

Returning to FIG. 12, the input is received through the editor tool and used to generate a markup document. The markup document may be generated by the content management server 102. The markup document may be generated using any object notation or language (e.g., JavaScript Object Notation (JSON), Hypertext Markup Language (HTML), etc.) to transmit the data objects described in the markup document.

At 1204, the input is correlated with the markup tags. For example, the input corresponding with a first field may identify a markup tag associated with that field. The determined markup tag and input may be added to the markup document. The standard markup tag may be correlated with text from the editor tool and the structured content markup tag may be correlated with the interactive data template from the editor tool. A resource identification location may also be correlated with input of the structured content markup tag and stored with the markup document.

At 1206, the markup document may be created and/or updated. The markup document may start with a language definition (e.g., <HTML>) that is written to the markup document. Depending on the input and fields from the editor tool that received data, various subsections of the markup document will also be added. For example, the interactions with the editor tool may identify a first template. The first template may be added to the markup document from a queue of templates available to add to the markup document. The first template may be added with the structured content markup tag identified with the editor tool process (e.g., DIV CLASS=“ . . . ”).

In some examples, headers may be added to the markup document as well. The headers may be placed at the beginning of a new section, as defined by the editor tool. The standard markup tag may be written to the markup document (e.g., <HEADER>) in addition to the formatting of the header (e.g., <H2 CLASS=“ . . . ”) and the text received by the editor tool (e.g., “this is my header”). The end of the header portion of the document may include another standard markup tag (e.g., </HEADER>).

In some examples, templates may be added to the markup document as well. The templates may be placed after the headers, as defined by the editor tool. The structured content markup tag may be written to the markup document (e.g., <DIV CLASS=“component_image”) in addition to the data type, uniform reference identifier, caption, description, or other information provided in association with the interactive structured data.

At 1208, the markup document may be transmitted to the structured content application. The markup document may comprise a complete definition of data objects and data provided by the first user device to render for the second user device by the structured content application. In some examples, the markup document may comprise resource identification locations to external locations. When determining data associated with the resource identification locations, the device retrieving the data may access external locations that are not contained within the markup document.

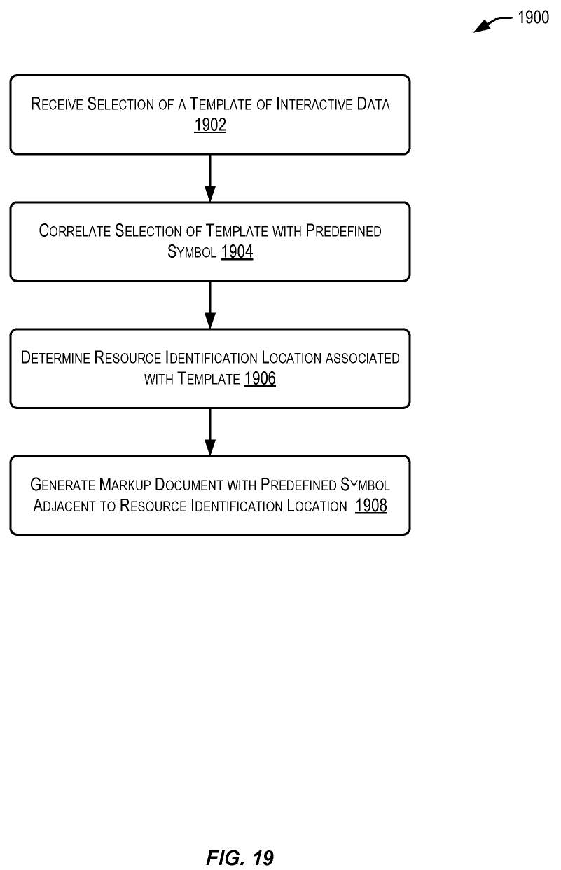

With reference now to FIG. 19, an illustrative flowchart related to the conversion of content to structured data is provided. In illustration 1900, a process may be implemented in various distributed or consolidated systems described herein, including a content distribution network 100, the content management server 102, user devices 106, or supervisor devices 110.

At 1902, a selection of a template of interactive structured data is received. The template may be generated by content management server 102. In some examples, a user device may operate in editor tool provided by a processor to select the template of the interactive structured data.

At 1904, the template may be correlated with predefined symbols. The correlation between the template and the predefined symbols may correspond with predefined symbols in a structure definition table of a database, and each predefined symbol may correspond with an attribute or a field from the template. For example, a first field in the template may select a particular type of interactive structured data selected through the editor tool (e.g., a timeline). The correlation with a predefined symbol may identify structured content markup tag for that interactive structured data (e.g., DIVCLASS=“component_timeline” DATA TYPE=“timeline” DATA URI=“abc123”). In this example, the first, second, and third predefined symbols may comprise “DIV CLASS,” “DATA TYPE,” and “DATA URI,” respectively. The predefined symbols may be placed adjacent to input from the editor tool or other data in the markup document.

Other predefined symbols are available as well. For example, the content management server 102 may correlate a “DIV CLASS” predefined symbol with a portion of the markup document that will be rendered by the structured content application. In another example, the content management server 102 may correlate a “HEADER” or other text that correspond with predefined symbols with other portions of the markup document that will be rendered by the structured content application.

At 1906, one or more resource identification locations (e.g., uniform resource identifiers, uniform resource locations, etc.) may be generated and/or selected for the correlated predefined symbols or other attributes of the template. For example, object data associated with the template may correspond with one or more resource identification locations stored in the database. This may include, for example, a stylized feature (e.g., line, box, circle, etc.) as object data that may be rendered and painted to the structured content application with the rest of the data from the template. The stored location of the object data may correspond with the resource identification location. The resource identification location corresponding with this object data may be added to the markup document along with the structured content markup tag to correlate the structured content markup tag with the location of the data.

In some examples, the structured content markup tag may only correspond with the template of interactive structured data. When the editor tool identifies data that may not be associated with the structured content data, a standard markup tag may be generated and added to the markup document along with the data (e.g., <HEADER> <H4 CLASS=“this is my header”> </HEADER>). In this example, the predefined symbol (e.g., “H4 CLASS”) is placed adjacent to input from the editor tool (e.g., “this is my header”) or other data in the markup document.

In some examples, access to the location corresponding with resource identification location may require authentication. During an authentication process, the user devices 106 may request access via a structured content application to the database. Authentication credentials of the user device may be stored with the structured content application. The structured content application may generate an authentication message with the credentials and transport them to the database associated with content management server 102. The content management server 102 may compare the credentials received in the authentication message with stored credentials and allow access to location corresponding with the resource identification location when the two sets of credentials match. The credentials may be stored with the structured content application during an enrollment process or credential generation process at the structured content application.

At 1908, the markup document is generated with the predefined symbol adjacent to the resource identification location. For example, content management server 102 may add standard markup tags with data and/or structured content markup tags with data to a markup document. The data may comprise content unique to the templates. The predefined symbol associated with the structured content markup tag may be written to the markup document and transmitted to the structured content application at the user device, as described throughout the disclosure. Further examples of the markup document are provided with FIG. 20.

With reference now to FIG. 20, an illustrative markup document with standard markup tags and structured content markup tags is provided. In illustration 2000, each type of markup tag may be surrounded by angle brackets, including a “<” and “>.” This may include <DIV CLASS=“component_image” DATA_TYPE=“image” DATA_URI=“ABC123”> as one complete structured content markup tag. In another example, <HEADER>, <H4 CLASS=“this is my header”>, and </READER> maybe three examples of standard markup tags. Each of these tag examples may comprise one or more parameters placed after the first angle bracket and before the second angle bracket.

The illustrative markup document in FIG. 20 may generate a timeline using a template of interactive structured data. Data objects corresponding with the timeline template may be defined throughout the markup document, including the structured content markup tag 2010. The structured content markup tag 2010 may comprise a resource identification location 2012 identifying a location of data corresponding to the timeline template. The rendering process may access this location to retrieve the data and incorporate the data with the rendered document at the user interface during the rendering process.

The markup document may also comprise one or more standard markup tags 2020, illustrated as 2020A and 2020B. The first standard markup tag 2020A may define a text-based header and the second standard markup tag 2020B may define a caption associated with an image for presentation at the user interface.

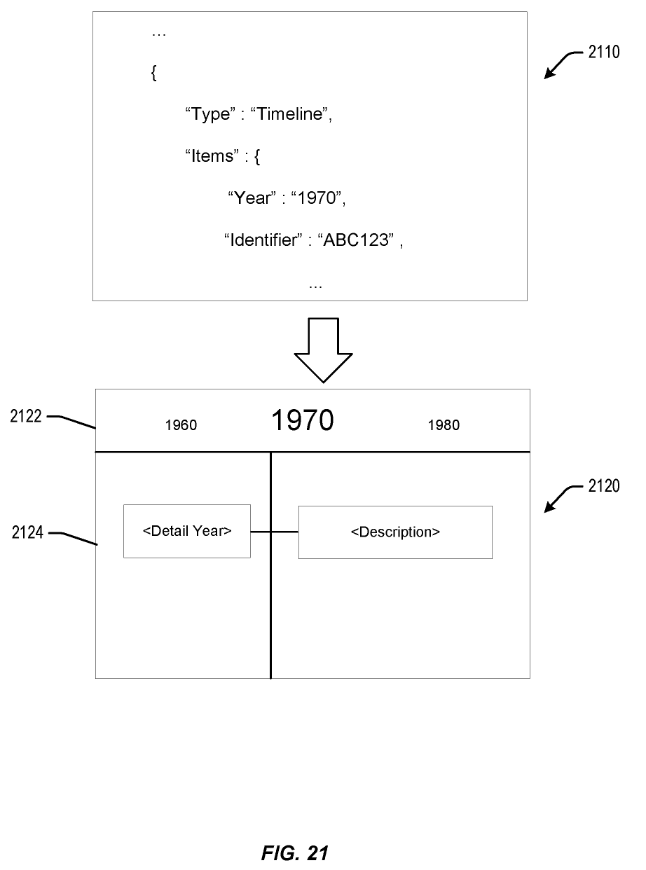

With reference now to FIG. 21, an illustrative markup document with a corresponding template is provided. In this example, a plurality of structured content markup tags are provided as attributes with corresponding structured data in a markup document 2110. The entries of the markup document 2110 may be generated and placed into the template of interactive structured data 2120 to form a new object to render with the user interface by the structured content application at the user device. When a plurality of structured content markup tags are provided in the markup document 2110, additional portions of the template 2120 may be generated to accept these additional structured content markup tags and data.

As illustrated, the markup document 2110 may comprise structured content markup tags corresponding with attributes of the timeline template. The determination of the timeline template is identified with attribute “TYPE” (timeline) in this example, but other attribute types are available without diverting from the disclosure. The timeline template may also accept data to customize the timeline template as attributes, including “YEAR” (1970) and “IDENTIFIER” (ABC123), which corresponds with the resource identification location stored with the database.

As further illustrated, the template 2120 may correspond with the timeline and incorporate the structured content markup tags and data identified in the markup document. The template 2120 may comprise a top portion 2122 containing one or more time ranges that may affect the display of the bottom portion 2124 of the timeline containing additional description included within those time ranges. The contents of the resource identification location from the markup document may also be presented with the template 2120. The machine code corresponding with the template 2120 may allow the selection of a time range once the template has been populated and rendered with the attributes and data from the markup document and stored.

When a user selects a time range, according to the machine code, the selection of the time range may alter the display of the bottom portion 2124 of the timeline data object. The bottom portion 2124 of the timeline data object may comprise individual years within the time range (e.g., 1971, 1972, etc.) and descriptions of events that occurred within the years within the time ranges. The viewable format of the top portion 2122 and the bottom portion 2124 may be defined by a structure definition table of the database corresponding with the timeline template (e.g., colors, font type, font size, layout, etc.). In some examples, the formatting of the template may be determined by attributes stored in the structure definition table of the database.

With reference now to FIG. 22, an illustrative markup document is provided. In illustration 2200, an assessment is provided instead of a timeline. The assessment may include a request for the user to provide a journal question and/or journal entry. The request may be presented at the user interface once the markup document has been rendered. As with the timeline template, the assessment template may correspond with formatting stored in the structure definition table of the database.

With reference now to FIG. 23, a block diagram is shown illustrating an embodiment of one or more user devices 106 within a content distribution network 100. In illustration 2300, the one or more user devices 106 may comprise one or more additional or alternative engines than embodiments previously discussed, including a network interface controller 2302 and a structured content application 2304 comprising one or more additional hardware or software modules, including a parser 2306, template determination engine 2308, rendering engine 2310, and object processor 2312. In some examples, the user devices 106 may correspond to any other combination of engines and modules described throughout the application to implement features described herein.

The network interface controller 2302 may transmit and receive data using a specific physical layer and datalink layer standard. For example, the data may be received from the content management servers 102 via a communication network, through a user interface at the user device via a user's direct interactions with the user device, or any other method of transmitting and receiving data discussed throughout the disclosure.

The network interface controller 2302 may also receive a markup document transmitted from content management servers 102. The markup document may be transmitted from the network interface controller at the content management servers 102 and received by a network interface controller 2302 at the user device. Each computer may implement the computer hardware component that connects the corresponding computer with the network interface controller to the communication network.

The one or more user devices 106 may also comprise a structured content application 2304. The structured content application 2304 may receive a markup document via the communication network and render, parse, and paint object data to the user interface based at least in part on the contents (e.g., data, tags, etc.) of the markup document. The structured content application 2304 may comprise various modules for rendering, parsing, and painting the object data based on the markup document, including a parser 2306, template determination engine 2308, rendering engine 2310, and object processor 2312. In some examples, the structured content application 2304 may follow at least a portion of standardized rules identified by the W3C (World Wide Web Consortium) organization or other standardized rules.

The structured content application 2304 of the user device may comprise a parser 2306. In some examples, the parser 2306 may receive the markup document (e.g., via the networking layer accessible by the network interface controller 2302) and translate the contents of the markup document to machine code and structure that may be used to render the user interface for display.

The parser 2306 may perform a tokenization process that can partition the input from the markup document into valid tokens of the machine code. The tokens of the machine code may be formed into a parse tree and analyzed according to language syntax rules. In some examples, irrelevant characters like whitespace and line breaks in the markup document may be removed during the parsing process.

The tokenization process may correspond with the state machine that receives one or more characters from the markup document or other input source and updates the next state of the state machine according to those characters. For example, the initial setting of the state machine may correspond with the “data state.” When a “<” character is received, the state may be changed to a “tag open state.” The received characters may be used to generate a token until other predefined characters are received from the input. When a “>” character is received, the state may be changed to a “tag closed state” or may return to the “data state.”

The structured content application 2304 of the user device may comprise a template determination engine 2308. In some examples, the template determination engine 2308 may determine data identified by the markup document in 8 KB chunks or packets of data. This data may comprise resource identification locations or other data identified in the markup document. The template determination engine 2308, and some examples, may analyze tokens that are generated from the parser 2306 and the corresponding tokenization process.

The template determination engine 2308 may access the constants, set of terms, or other data that are stored with a database and correlate them with the template structure stored with a structured definition table of the database. In some examples, the data specified by the user with the content management servers 102 may be incorporated with the template by the template determination engine 2308.

The template determination engine 2308 may also determine styles according to the templates identified in the markup document. The style definitions may be common across all iterations of a particular template. For example, each time that the template determination engine 2308 identifies a timeline template from a markup document, the generated timeline may use common colors, fonts, spacing, and other formatting details in conjunction with unique constants, sets of terms, or other data that are stored with a database and identified through the editor tool with the content management servers 102.

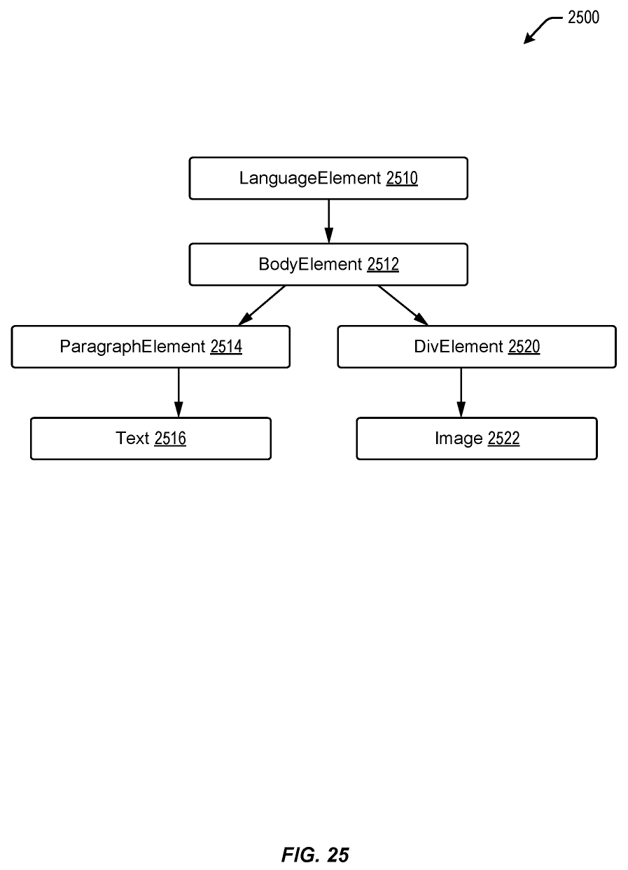

The structured content application 2304 may comprise a rendering engine 2310. In some examples, the rendering engine 2310 may parse the markup document and convert the elements of the markup document to nodes of a content tree. The nodes of the content tree may correspond with a document object model (DOM) tree that identifies style data with visual attributes like color and dimensions that correspond with object data eventually rendered to the user interface by the structured content application. An illustrative example of the DOM tree is provided with FIG. 25.

The rendering of the tree may correspond with an order in which to paint the object data to the user interface (e.g., “first, second, third” or “top, middle, bottom,” etc.) in a global or incremental process. In some examples, the order for painting the object data to the user interface may correspond with a background color first, followed by a background image, border, text, and rendering of the templates.

The structured content application 2304 may also comprise a object processor 2312. In some examples, the object processor 2312 may traverse the tree generated by the rendering engine 2310 to correlate exact coordinates of the user interface that may be provided by the structured content application with each corresponding node of the tree. In some examples, the object processor 2312 may follow the order identified by the rendering engine 2310.

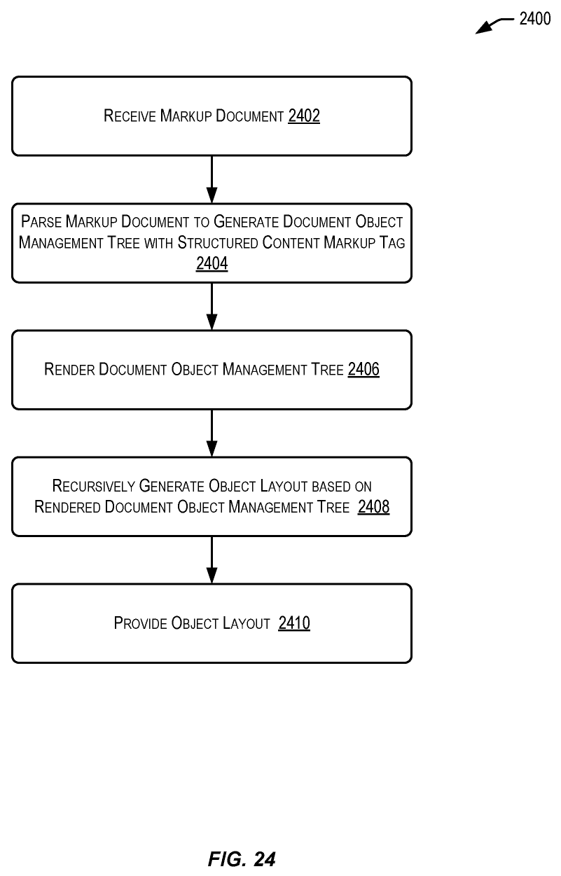

With reference now to FIG. 24, an illustrative flowchart related to the conversion structured data to an object layout is provided. In illustration 2400, a process may be implemented in various distributed or consolidated systems described herein, including a content distribution network 100, the content management server 102, user devices 106, or supervisor devices 110.

At 2402, a markup document may be received. For example, the user device 106 may receive the markup document via a communication network from the content management server 102. The user device 106 may receive the markup document using the network interface controller and/or the structured content application provided by the processor of the user device. The markup document may comprise entries for one or more standard markup tags and one or more structured content markup tags, along with corresponding structured data or unstructured data for the tags.

At 2404, the markup document may be parsed to generate a document object management tree with the one or more standard markup tags and one or more structured content markup tags. For example, the parser 2306 of the user device 106 executed by the structured content application may parse the markup document.

At 2406, the document object management tree may be rendered. For example, the structured content application of the user device may render the document object management tree based at least in part on the parsing of the markup document. For example, the rendering engine 2310 of the user device 106 executed by the structured content application may render the document object management tree.

In some examples, the process may also access a resource identification location associated with the structured data and/or the structured content markup tag. For example, the template determination engine 2308 may receive and incorporate templates of interactive structured data associated with the resource identification location(s) from the parsed document. The resource identification location may correspond with a structured data object to display with an object layout. In some examples, the resource identification location may comprise any constants, sets of terms, or other data received from the user device in addition to any data or predefined terms stored with the template definition in the structure definition table of the database. The format of data stored at the resource identification location may correspond with a function call of a programming language (e.g., JSON, etc.) or other data set that may be read across multiple or different platforms. The object layout, incorporating the standard data and structured content data, may be rendered for presentation at a user interface. The structured data object may be populated with at least a portion of structured data corresponding with the resource identification location from the markup document.

In some examples, the structured data may be rendered instantly without accessing a resource identification location. The structured content application may determine the rendering details of the template of interactive structured data based at least in part on the user device's screen size and processing capabilities. For example, a relatively slow processor (when compared to a threshold) may render the template without interactive capabilities. The interactive image, for example, may be displayed as a static image. This may be beneficial to continue transmitting and displaying data by the structured content application without losing processing capabilities for the remainder of the data.

At 2408, an object layout may be generated. For example, the structured content application 2304 of the user device (e.g., by the object processor 2312) may recursively traverse the rendered document object management tree in order to generate the object layout that corresponds with the tree. The object layout may comprise at least a structured data object and a standard data object corresponding with the standard markup tags from the markup document.

In some examples, the platform corresponding with the user device may affect the process for generating an object layout. As an example illustration, a first user device may download a first structured content application that corresponds with an iOS operating system platform while a second user device may download a second structured content application that corresponds with a Windows operating system platform. The two structured content applications may present the application content on the user interface differently, based at least in part on the platform of the user device. The object layout and rendering may be performed by the structured content application that corresponds with the particular platform, prior to displaying the markup document or object data associated with the rendered markup document.

For example, the structured content applications may differ during object processing. The origin location on a user interface of both the first structured content application and the second structured content application may include the top left corner of the user interface. Both structured content applications may comprise axes that extend down and to the right from the origin point in the top left corner of the user interface. The structured content applications may differ by, for example, the second structured content application including a local coordinate system that allow specification of coordinates relative to the view or window origin instead of relative to the screen to allow for precise layout and positioning of data regardless of the underlying screen resolution. As such, the markup document may be common across multiple platforms and the process for generating the object layout may be unique for each platform.

At 2410, the object layout may be provided. For example, the structured content application may paint the contents of the object layout to the user interface. The painting a correspond with an order of data objects from the tree or object layout.

With reference now to FIG. 25, an illustrative parsing tree related to the conversion structured data to an object layout is provided. In illustration 2500, a parsing process is shown that is performed by a structured content application at a user device. For example, a portion machine code may comprise a language element 2510 (e.g., <HTML>), a body element 2512 (e.g., paragraph, header, etc.), and specifics of each body element within the machine code written to the markup document, including a paragraph element 2514 (e.g., <P>) with corresponding text of the paragraph 2516 (e.g., “this is a description of an image”), a DIV element 2520 (e.g., <DIV>) with a corresponding image 2522. The parsing process may recursively traverse the markup document to generate a parsing tree similar to the illustration 2500. Once the tree has been generated, each token associated with the tree may be defined in a specification for the language element associated with the machine code.

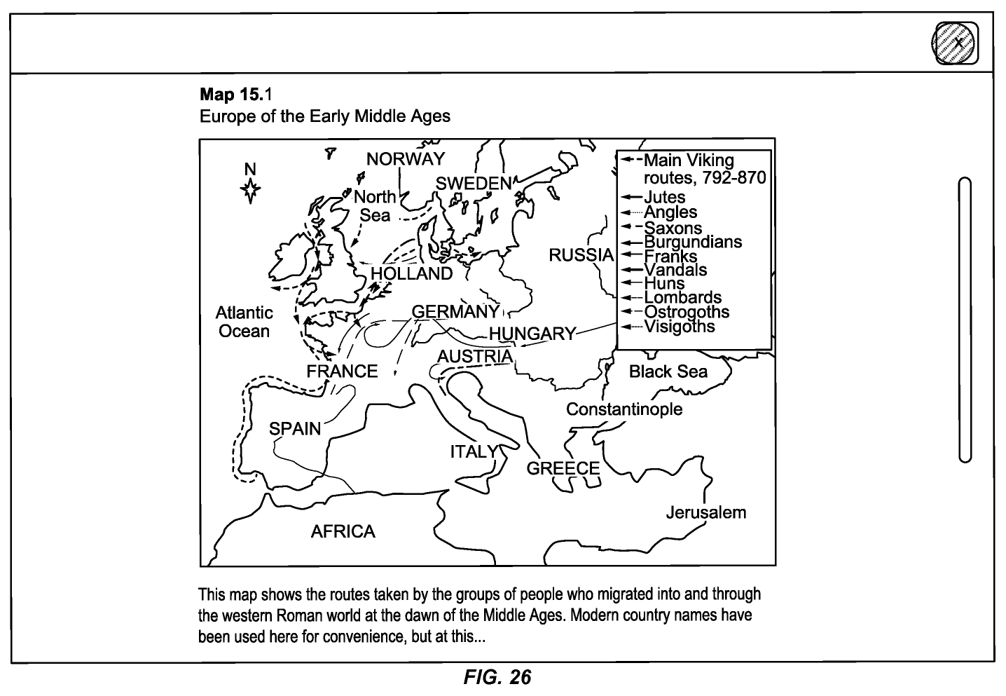

With reference now to FIG. 26, an illustrative user interface infrastructure component is provided. In illustration 2600, an example of a painted plurality of data objects shows an image, caption, description, and additional text at the user interface of a user device provided by a structured content application. The painted plurality of data objects may differ across different platforms as well, as illustrated with FIG. 18.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

1. A computer-implemented method for rendering a markup language document, the method comprising:
receiving, by a structured content application configured to generate, read, and render a custom markup language portable across a plurality of platforms and communicative protocols and provided by a processor, a markup document comprising a customized document, which does not rely on code-based instructions, to be displayed on a destination user device running a specific platform, the markup document having been generated using a graphical user interface (GUI) within the structured content application, wherein the markup document comprises a standard markup tag and a structured content markup tag in the custom markup language that is unique to the structured content application and to the destination user device;
parsing the markup document to generate a document object management tree that comprises entries for the standard markup tag, the structured content markup tag, and a structured data in the document object management tree;
rendering the document object management tree based at least on the parsing;
accessing a resource identification location associated with the structured data, wherein:
the resource identification location corresponds with a structured data object to display with an object layout, and
the structured data object is populated with at least a portion of the structured data from the markup document;
recursively generating the object layout that represents the rendered document object management tree, the object layout comprising at least the structured data object and a standard data object corresponding with the standard markup tag from the markup document; and
providing the object layout via the structured content application, wherein the object layout provided by the structured content application corresponds with a platform executed by the processor, and a second structured content application provides the object layout differently based on a corresponding platform and wherein the object layout comprises a consistent display across the corresponding platforms.

2. The computer-implemented method of claim 1, wherein the parsing further comprises:
removing whitespace and line breaks in the markup document.

3. The computer-implemented method of claim 1, wherein the rendering of the document object management tree is implemented as a state machine, wherein the state machine converts to a different state when a particular character is received during the parsing.

4. The computer-implemented method of claim 1, wherein the parsing generates tokens that are used to determine a template of interactive structured data.

5. The computer-implemented method of claim 4, wherein the template corresponds with the structured content markup tag and a template structure stored with a structure definition table of a database.

6. The computer-implemented method of claim 1, wherein the structured content browser application is downloaded by the user device prior to providing the object layout.

7. A computing device for rendering a markup language document, the computing device comprising:
one or more processors; and
one or memories coupled with the one or more processors, wherein the one or more processors and the one or more memories are configured to:
receive, by a structured content application configured to generate, read, and render a custom markup language portable across a plurality of platforms and communicative protocols and provided by the one or more processors, a markup document comprising a customized document, which does not rely on code-based instructions, to be displayed on a destination user device running a specific platform, the markup document having been generated using a graphical user interface (GUI) within the structured content application, wherein the markup document comprises a standard markup tag and a structured content markup tag in the custom markup language that is unique to the structured content application and to the destination user device;
parse the markup document to generate a document object management tree that comprises entries for the standard markup tag, the structured content markup tag, and a structured data in the document object management tree;
render the document object management tree based at least on the parsing;
access a resource identification location associated with the structured data, wherein:
the resource identification location corresponds with a structured data object to display with an object layout, and
the structured data object is populated with at least a portion of the structured data from the markup document;
recursively generate the object layout that represents the rendered document object management tree, the object layout comprising at least the structured data object and a standard data object corresponding with the standard markup tag from the markup document; and
provide the object layout via the structured content application, wherein the object layout provided by the structured content application corresponds with a platform executed by the processor, and a second structured content application provides the object layout differently based on a corresponding platform and wherein the object layout comprises a consistent display across the corresponding platforms.

8. The computing device of claim 7, wherein the parsing further comprises: removing whitespace and line breaks in the markup document.

9. The computing device of claim 7, wherein the rendering of the document object management tree is implemented as a state machine, wherein the state machine converts to a different state when a particular character is received during the parsing.

10. The computing device of claim 7, wherein the parsing generates tokens that are used to determine a template of interactive structured data.

11. The computing device of claim 10, wherein the template corresponds with the structured content markup tag and a template structure stored with a structure definition table of a database.

12. The computing device of claim 7, wherein the structured content browser application is downloaded by the user device prior to providing the object layout.

13. One or more computer-readable storage media collectively storing computer-executable instructions that, when executed by one or more computer systems, configure the one or more computer systems to collectively perform operations comprising:
receiving, by a structured content application configured to generate, read, and render a custom markup language portable across a plurality of platforms and communicative protocols and provided by a processor, a markup document comprising a customized document, which does not rely on code-based instructions, to be displayed on a destination user device running a specific platform, the markup document having been generated using a graphical user interface (GUI) within the structured content application, wherein the markup document comprises a standard markup tag and a structured content markup tag in the custom markup language that is unique to the structured content application and to the destination user device;
parsing the markup document to generate a document object management tree that comprises entries for the standard markup tag, the structured content markup tag, and a structured data in the document object management tree;
rendering the document object management tree based at least on the parsing;
accessing a resource identification location associated with the structured data, wherein:
the resource identification location corresponds with a structured data object to display with an object layout, and
the structured data object is populated with at least a portion of the structured data from the markup document;
recursively generating the object layout that represents the rendered document object management tree, the object layout comprising at least the structured data object and a standard data object corresponding with the standard markup tag from the markup document; and
providing the object layout via the structured content application, wherein the object layout provided by the structured content application corresponds with a platform executed by the processor, and a second structured content application provides the object layout differently based on a corresponding platform and wherein the object layout comprises a consistent display across the corresponding platforms.

14. The computer-readable storage media of claim 13, wherein the parsing further comprises:
removing whitespace and line breaks in the markup document.

15. The computer-readable storage media of claim 13, wherein the rendering of the document object management tree is implemented as a state machine, wherein the state machine converts to a different state when a particular character is received during the parsing.

16. The computer-readable storage media of claim 13, wherein the parsing generates tokens that are used to determine a template of interactive structured data.

17. The computer-readable storage media of claim 16, wherein the template corresponds with the structured content markup tag and a template structure stored with a structure definition table of a database.

18. The computer-readable storage media of claim 13, wherein the structured content browser application is downloaded by the user device prior to providing the object layout.
